(19) United States
(12) Patent Application Publication
(10) Pub. No.: US 2013/0088889 A1
(43) Pub. Date: Apr. 11, 2013

(54) BACKLIGHT UNIT AND DISPLAY DEVICE HAVING THE SAME

(71) Applicants: YOUNGCHAN KIM, Incheon (KR); MOONGYU LEE, Suwon-si (KR); HWANYOUNG CHOI, Yongin-si (KR); UnByoll KO, Yeoju-gun (KR); Hyungwoo YIM, Suwon-si (KR)

(72) Inventors: YOUNGCHAN KIM, Incheon (KR); MOONGYU LEE, Suwon-si (KR); HWANYOUNG CHOI, Yongin-si (KR); UnByoll KO, Yeoju-gun (KR); Hyungwoo YIM, Suwon-si (KR)

(73) Assignee: SAMSUNG DISPLAY CO., LTD., Yongin-City (KR)

(21) Appl. No.: 13/604,002

(22) Filed: Sep. 5, 2012

(30) Foreign Application Priority Data
Oct. 10, 2011 (KR) 10-2011-0103225
Feb. 9, 2012 (KR) 10-2012-0013427
Mar. 27, 2012 (KR) 10-2012-0031161

(51) Int. Cl. G09F 13/18; F21V 13/12

(52) U.S. Cl. 362/602; 362/607

(57) ABSTRACT

A backlight unit includes a light guide unit, light source units, a prism sheet and a lens sheet. The light guide unit includes opposing first and second edges, a light exiting surface connecting the first and second edges and first and second light guide plates. A region of the first light guide plate adjacent to the first edge is thicker than a region of the first light guide plate adjacent to the second edge, and a region of the second light guide plate adjacent to the second edge is thicker than a region of the second light guide plate adjacent to the first edge. The light source units are adjacent to the first and second edges, respectively. The prism sheet includes a plurality of prisms on a surface facing the light guide unit. The lens sheet includes a plurality of lenses facing the prism sheet.

This application claims priority to Korean Patent Application Nos. 10-2011-0103225 filed Oct. 10, 2011, 10-2012-0013427 filed Feb. 9, 2012, and 10-2012-0031161 filed Mar. 27, 2012, the entirety of which is incorporated by reference herein.

### BACKGROUND

(1) Field

The invention relates to a backlight unit and a display device including the same, and more particularly, relates to a backlight unit enabling display of both a planar image and a 3-dimensional (“3D”) image, and a display device including the same.

(2) Description of the Related Art

A display device capable of displaying both a planar image and a 3D image has been developed. In general, a 3D image display device may be configured to divide a 3D image such that an image for a left eye and an image for a right eye are provided to a left eye and a right eye of a viewer, respectively. Due to binocular disparity, the viewer may see the image for a left eye and the image for a right eye via both eyes to observe a 3D effect. Also, a planar image display device may provide a viewer with an image without separating the image into an image for a left eye and an image for a right eye, and the viewer may watch the planar image.

In order to watch a 3D image, a viewer may use glasses for watching the 3D image. For this reason, it is desired to develop a display device capable of viewing a 3D image without putting on glasses for watching the 3D image.

### SUMMARY

One or more embodiments of the invention concept provide a backlight unit which includes a light guide unit, light source units, a prism sheet and a lens sheet. The light guide unit has a first edge, a second edge opposed to the first edge, and a light exiting surface connecting the first edge and the second edge. The light guide unit includes a first light guide plate and a second light guide plate. A region of the first light guide plate adjacent to the first edge is thicker than a region of the first light guide plate adjacent to the second edge, and a region of the second light guide plate adjacent to the second edge is thicker than a region of the second light guide plate adjacent to the first edge. The light source units are disposed adjacent to the first and second edges of the light guide unit. The prism sheet is disposed at the upper part of the light guide unit, and has a plurality of prisms disposed on a surface facing the light guide unit. The lens sheet is disposed at the upper part of the prism sheet, and has a plurality of lenses.

An angle between a virtual line bisecting an apex angle of each prism and a virtual line parallel with a thickness direction of the prism sheet may become larger as the prism is closer to the light source unit with respect to a center point of the prism sheet, the center point at half a distance between edges of the prism sheet, and the edges of the prism sheet are respectively adjacent to the light source units.

An angle between the virtual line bisecting an apex angle of each prism and the virtual line parallel with a thickness direction of the prism sheet may be symmetrical with respect to the center point of the prism sheet.

A distribution distance of a light passing through the lens sheet and diffused at an entire eye area of a viewer is determined by:

$$A = \frac{P ( {L}_{VD} - L )}{L}$$

where P indicates a pitch between lenses, L indicates a focusing distance of a lens sheet, and L_{VD} indicates a viewing distance of the viewer.

The prism sheet may further include a lower surface opposing the light exiting surface thereof. Each prism may include a first tilt surface extended from the lower surface in a direction inclined with respect to a direction perpendicular to the lower surface; a second tilt surface extended from the lower surface in a direction intersected with a virtual line of the first tilt surface; and a connection surface connecting the first tilt surface and the second tilt surface.

An angle formed by a virtual line bisecting an apex angle of each prism and a virtual line perpendicular to the lower surface of the prism sheet may become larger as the prisms are closer toward first and second edges of the prism sheet with respect to a center point of the prism sheet. The center point of the prism sheet is at half a distance between the first and second edges of the prism sheet, and the first and second edges of the prism sheet are respectively adjacent to the light source units. The apex angle is formed by the first tilt surface and a virtual line of the second tilt surface.

The prism sheet may further include a lower surface opposing the light exiting surface thereof. Each of the prisms includes a first tilt surface connected to the lower surface, and a second tilt surface intersected with the first tilt surface and connected to the lower surface. A prism of which an apex angle is bisected by a virtual line perpendicular to the lower surface and passing through an intersected point of the first and second tilt surfaces is spaced apart from a center point of the prism sheet. The center point of the prism sheet is half a distance between edges of the prism sheet, and the edges of the prism sheet are respectively adjacent to the light source units. The apex angle is formed by the first and second tilt surfaces.

One or more embodiments of the invention provide a display device which includes the backlight unit and a display panel.

### BRIEF DESCRIPTION OF THE DRAWINGS

The above and other features will become apparent from the following description with reference to the following figures, wherein like reference numerals refer to like parts throughout the various figures unless otherwise specified, in which

FIG. 1 is a perspective exploded view of an exemplary embodiment of a display device according to the invention.

FIG. 2 is a conceptual view illustrating an exemplary embodiment of a backlight unit in FIG. 1.

FIG. 3 is a cross-sectional view illustrating, in part, an exemplary embodiment of a light source unit, a light guide unit, and a reflection sheet illustrated in FIG. 1.

FIG. 4A is a cross-sectional view of an exemplary embodiment of a prism sheet illustrated in FIG. 1.

FIGS. 4B through 4D are enlarged diagrams of regions B, C, and D in FIG. 4A, respectively.

FIG. 5 is a cross-sectional view of an exemplary embodiment of a lens sheet illustrated in FIG. 1.

FIG. 6A is a diagram illustrating a distribution of a light passing through the prism sheet of the display device in FIG. 1.

FIG. 6B is a diagram illustrating a distribution of a light passing through the prism sheet and the lens sheet of the display device in FIG. 1.

FIG. 7 is a graph illustrating a distribution of a light passing through the lens sheet of the display device in FIG. 1.

FIG. 8A is a cross-sectional view of another exemplary embodiment of a prism sheet applicable to a display device in FIG. 1 according to the invention.

FIGS. 8B to 8D are enlarged diagrams of regions B′, C′, and D′ in FIG. 8A, respectively.

FIG. 9 is a diagram illustrating an exemplary embodiment of a shape of a prism of the prism sheet illustrated in FIGS. 8A to 8D.

FIG. 10 is a diagram illustrating a light path with respect to the prism sheet illustrated in FIGS. 8A, 8B and 9.

FIG. 11A is a graph illustrating a distribution of lights which are output from a display device having a prism sheet in FIGS. 4A to 4D and reach a viewing distance.

FIG. 11B is a graph illustrating a distribution of lights which are output from a display device having the prism sheet in FIGS. 8A to 8D and 9 and which reach a viewing distance.

FIGS. 12 to 15 are cross-sectional views of alternative exemplary embodiments of prisms of the prism sheet in FIGS. 8A to 8D and 9 according to the invention.

FIG. 16 is a graph illustrating a distribution of lights output from each point of the light guide unit in FIG. 3, which are provided to a right eye of a viewer.

FIG. 17 is a graph illustrating a distribution of lights output from each point of the light guide unit in FIG. 3, which are provided to a left eye of a viewer.

FIG. 18A is a cross-sectional view of still another exemplary embodiment of a prism sheet applicable to a display device in FIG. 1 according to the invention.

FIGS. 18B to 18D are enlarged views of regions B″, C″, and D″ in FIG. 18A, respectively.

FIG. 19 is a conceptual view illustrating a prism of which a virtual line perpendicular to an upper surface of a prism sheet bisects the apex angle of the prism, is spaced apart from a point of a prism sheet corresponding to half a distance between edges of the prism sheet, respectively adjacent to light source units.

FIGS. 20A and 20B are graphs illustrating a distribution according to lights output from a backlight unit based on a location of a prism of which the apex angle is bisected by a virtual line perpendicular to an upper surface at a prism sheet.

FIG. 21 is a cross-sectional view illustrating another exemplary embodiment of a backlight unit used in a display device according to the invention.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “lower” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the specification and will not be interpreted in an idealized or overly formal sense unless expressly so defined herein.

Hereinafter, the invention will be described in detail with reference to the accompanying drawings.

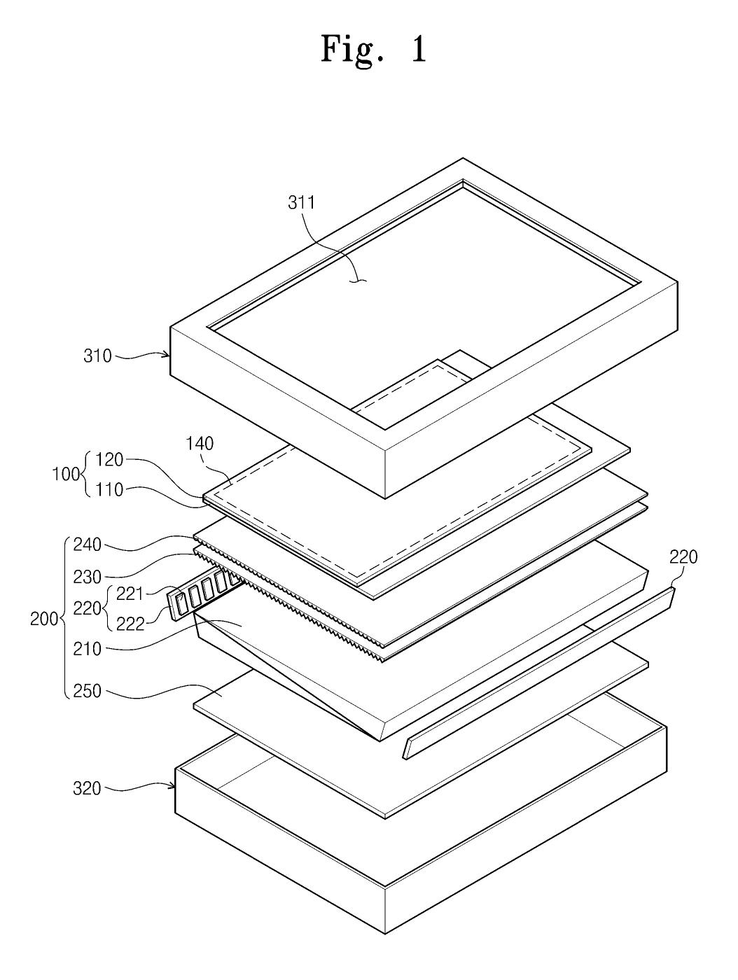

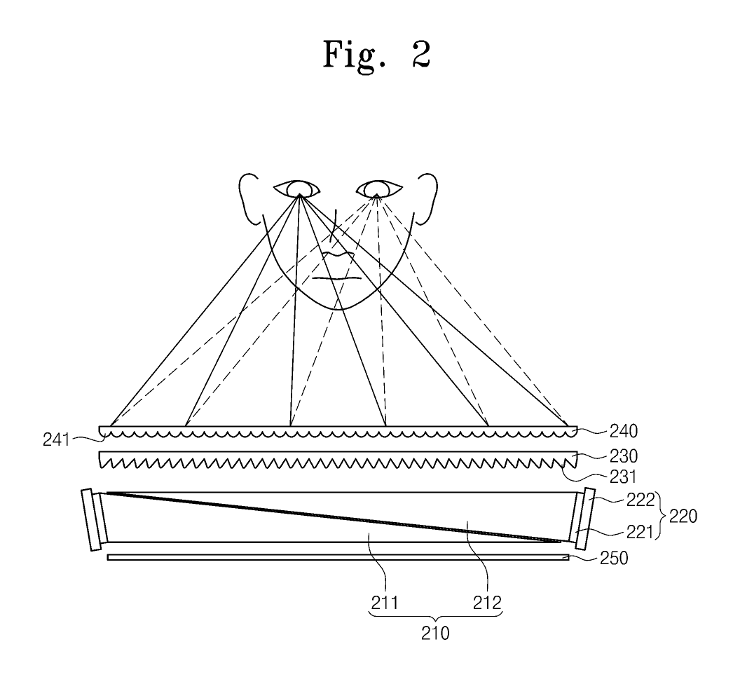

FIG. 1 is a perspective exploded view of an exemplary embodiment of a display device according to the invention. FIG. 2 is a conceptual view illustrating an exemplary embodiment of a backlight unit in FIG. 1.

Referring to FIGS. 1 and 2, an exemplary embodiment of a display device according to the invention may include a display panel 100, a backlight unit 200, a top cover 310, and a bottom cover 320.

The display panel 100 may have a display region 140 for displaying an image, and the display region 140 may display an image using a light. The display panel 100 may include a liquid crystal display panel, an electrophoretic display panel, or the like. In the exemplary embodiment, the display panel 100 may be a liquid crystal display panel.

The display panel 100 may be provided as a tetragonal plate having a long edge and a short edge. The display panel 100 may include an array substrate 110, an opposite substrate 120 facing the array substrate 110, and a liquid crystal layer (not shown) between the array substrate 110 and the opposite substrate 120.

Although not shown in the figures, the array substrate 110 may include one or more gate lines extended along a first direction, and one or more data lines extended along a second direction intersected with the first direction, so as to be intersected with and insulated from the gate lines.

The array substrate 110 may further include a plurality of pixels arranged in a matrix form, although not shown in figures. Each pixel may include a thin film transistor and a pixel electrode, although not shown in figures. Herein, a gate electrode of a thin film transistor may be electrically connected to a corresponding one of the gate lines, a source electrode of the thin film transistor may be connected to a corresponding one of the data lines, and a drain electrode of the thin film transistor may be electrically connected to the pixel electrode. Thus, the thin film transistor may switch a pixel between an on-state and an off-state, thereby controlling or driving signal to the pixel electrode.

Although not shown in figures, the opposite substrate 120 may include a red, blue and green (“RGB”) color filter, which is provided on one surface of the opposite substrate 120 and realizes a color using a light, and a common electrode which is on the RGB color filter and faces the pixel electrode. In an exemplary embodiment, the RGB color filter may be formed using a thin film process. It has been described that a color filter is on the opposite substrate 120. However, the invention is not limited thereto. In an alternatively exemplary embodiment, for example, the color filter can be on the array substrate 110.

Liquid crystal molecules of the liquid crystal layer may be arranged in a specific direction by voltages applied to the pixel electrode and the common electrode to adjust the transmittance of a light from the backlight unit 200. That is, an image may be displayed by the display panel 100 using the arranged liquid crystal molecules and light from the backlight unit 200.

The backlight unit 200 may be disposed to face a first surface of opposing surfaces of the display panel 100, for example, facing a surface opposite to an external (hereinafter, referred to as ‘bottom’) direction of the array substrate 110, and may supply a light to the display panel 100. A light supplied to the display panel 100 may be output from a second surface of the display panel 100 opposite to the first surface, that is, an external (hereinafter, referred to as ‘top’) direction of the opposite substrate 120, such that the display panel 100 displays an image.

Herein, the backlight unit 200 may include a light guide unit 210 guiding a light, one or more light source units 220 supplying a light to the light guide unit 210, a prism sheet 230, a lens sheet 240 and a reflection sheet 250. In

The light guide unit 210 may be disposed below the display panel 100, and the light guide unit 210 may guide a light emitted from the light source units 220 so as to be output toward the display panel 100. The light guide unit 210 may have a tetragonal shape corresponding to a shape of the display panel 100. As used herein, corresponding may indicate being substantially similar in dimension, material and/or location relative to another element. The light guide unit 210 may overlap at least the display region 140 of the display panel 100. As illustrated in the exemplary embodiment, For example, the light guide unit 210 may include a first edge, a second edge opposite to the first edge, and third and fourth edges connecting the first edge and the second edge to each other.

The light guide unit 210 may have an upper surface, a lower surface opposite to the upper surface, and a plurality of lateral surfaces connecting the upper surface and the lower surface to each other. At least one of the plurality of lateral surfaces may be an incident surface on which a light emitted from the light source unit 220 is incident. The upper surface may be an output surface by which the light is guided and which outputs a light toward the display panel 100.

The light guide unit 210 may include a first light guide plate 211 and a second light guide plate 212. Each of the first and second light guide plates 211 and 212 may be a wedge-shaped light guide plate. As illustrated in the exemplary embodiment, for example, a thickness of a region of the first light guide plate 211 adjacent to the first edge may be larger than that of a region of the first light guide plate 211 adjacent to the second edge. A thickness of a region of the second light guide plate 212 adjacent to the second edge may be larger than that of a region of the second light guide plate 212 adjacent to the first edge. The thicknesses are taken perpendicular to the reflection sheet 250. Thus, the first edge of the first light guide plate 211 may correspond to the second edge of the second light guide plate 212, and the second edge of the first light guide edge 211 may correspond to the first edge of the second light guide plate 212. A lateral surface corresponding to the first edge of the first light guide plate 211 and a lateral surface corresponding to the second edge of the second light guide plate 212 may be an incident surface on which a light emitted from the light source unit 220 is incident.

Each of the first and second light guide plates 211 and 212 may include a transparent material capable of refracting a light. In one exemplary embodiment, for example, each of the first and second light guide plates 211 and 212 may include transparent polymer resin such as polycarbonate, polymethyl methacrylate, or the like.

The light source units 220 may be disposed to be adjacent to two parallel edges of the light guide unit 210, for example, the first edge and the second edge. In detail, one light source unit 220 may be disposed to be adjacent to the first edge, and may supply a light to the first light guide plate 211. The other light source unit 220 may be disposed to be adjacent to the second edge, and may supply a light to the second light guide plate 212.

The light source unit 220 may include at least one light source 221 generating and emitting light, and a printed circuit board 222 applying a power to the light source 221. The light source 221 may be mounted on a first surface of the printed circuit board 222. The light source 221 may be a cold cathode fluorescent lamp (“CCFL”) or a light emitting diode (“LED”). A radiation member (not shown) for emitting heat generated by the light source 221 may be disposed on a second surface of the printed circuit board 222 opposite to the first surface including the light source 221 mounted thereon. The printed circuit board 222 may have a longitudinal axis which extends in a first direction, for example, parallel to a long side of the display panel 100.

The prism sheet 230 may be disposed in a direction where a light from the light guide unit 210 is output. That is, the prism sheet 230 may be disposed between the light guide unit 210 and the display panel 100. The prism sheet 230 may include a plurality of prisms 231 which are disposed on a surface of the prism sheet 230 that faces the light guide unit 210. Herein, the prism sheet 230 may refract a light from the light guide unit 210 in an angle corresponding to the binocular disparity. Each prism 231 may have a longitudinal axis which extends parallel to the longitudinal axis of the printed circuit board 222. The prisms 231 may be arranged from one edge of the prism 230 adjacent to a light source unit 220, to the opposing edge thereof adjacent to another light source unit 220.

The lens sheet 240 may be disposed in a direction where a light from the prism sheet 230 is output. That is, the lens sheet 240 may be disposed between the prism sheet 230 and the display panel 100.

The lens sheet 240 may diffuse a light, which is refracted by the prism sheet 230 in an angle corresponding to the binocular disparity of a viewer, toward an entire eye area of the viewer. The lens sheet 240 may include a plurality of lenses 241 which are disposed on a first surface of the lens sheet 240 that faces the prims sheet 230.

The lens sheet 240 may include a plurality of lenses 241 which is disposed on the first surface of the lens sheet 240. The lenses 241 may have a longitudinal axis which extends from one end of the light source unit 220, to the other end thereof. A pitch between the lenses 241 of the lens sheet 240 is equal to a pitch between the prisms 231 of the prism sheet 230. In an alternative embodiment, for example, the lenses 241 may be disposed on a surface opposite to the prism sheet 230. That is, the lenses 241 may be disposed on a surface of the lens sheet 240 that does not face the prism sheet 230, that is, on a surface facing the display panel 100. In the illustrated exemplary embodiment, the lenses 241 are disposed on a surface of the lens sheet 240 facing the prism sheet 230, but the invention is not limited thereto.

The top cover 310 may be provided at the upper part of the display panel 100, and may have a shape corresponding to a shape of the display panel 100. The top cover 310 may include a display window 311 which exposes the display region 140 of the display panel 100. The top cover 310 may include an upper surface supporting a front edge of the display panel 100, and a plurality of top cover lateral surfaces extended from the upper surface and bent in the direction of the bottom cover 320. Herein, since the display panel 100 may have a tetragonal plate shape, the top cover 310 may include four top cover lateral surfaces. The top cover 310 may be joined with the bottom cover to support entire edges of the display panel.

The bottom cover 320 may be disposed at a lower part of the backlight unit 200. The bottom cover 320 may include a lower surface to correspond to planar shapes of the display panel 100 and the backlight unit 200 and a plurality of bottom cover lateral surfaces extended from the lower surface and bent upwards towards the display panel 100. Herein, since the display panel 100 may have a tetragonal shape, the bottom cover 320 may include four bottom cover lateral surfaces. The lower surface and the bottom cover lateral surfaces of the bottom cover 320 may form an internal space in which the display panel 100 and the backlight unit 200 are received. The bottom cover 320 may be joined with the top cover 310 to receive and support the display panel 100 and the backlight unit 200 within the internal space.

As described above, an exemplary embodiment of a display device according to the invention may enable a viewer to see a three-dimensional (“3D”) image without a separate tool for seeing a 3D image such as the polarization glasses.

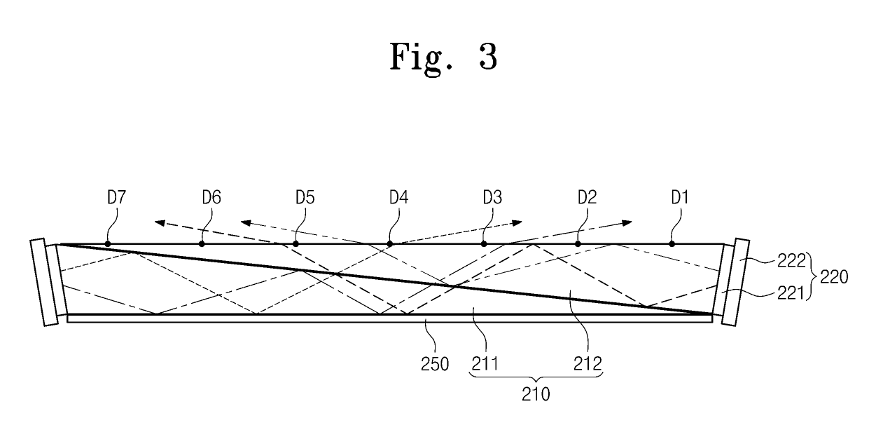

FIG. 3 is a cross-sectional view illustrating, in part, an exemplary embodiment of a light source unit, a light guide unit and a reflection sheet illustrated in FIG. 1. FIG. 3 illustrates an exemplary embodiment where light is output from a surface of the light guide unit.

Referring to FIG. 3, a light guide unit 210 may include a first light guide plate 211 and a second light guide plate 212 each of which is a wedge-shaped plate. A first edge of the first light guide plate 211 may correspond to a second edge of the second light guide plate 212, and a second edge of the first light guide plate 211 may correspond to a first edge of the second light guide plate 212. Herein, the first light guide plate 211 and the second light guide plate 212 (or, facing surfaces thereof) may contact each other. Alternatively, the first light guide plate 211 and the second light guide plate 212 may be spaced apart from each other, with an air layer interposed therebetween.

A lateral surface of the light guide unit 210 corresponding to the first edge of the first light guide plate 211, and a lateral surface of the light guide unit 210 corresponding to the second edge of the second light guide plate 212 may be inclined with respect to a surface parallel with the thickness direction of the light guide unit 210. The light source units 220 may be disposed at a lateral surface of the light guide unit 210 corresponding to the first edge of the first light guide plate 211 and at a lateral surface of the light guide unit 210 corresponding to the second edge of the second light guide plate 212, respectively. That is, the light source units 220 may be disposed to be opposite to each other with respect to the light guide unit 210. A lateral surface of the first light guide plate 211 parallel to the first edge of the first light guide plate 211 may be an incident surface, and a lateral surface of the second light guide plate 212 parallel to the second edge of the second light guide plate 212 may be an incident surface.

The lateral surface of the first light guide plate 211 corresponding to the first edge of the first light guide plate 211, and the lateral surface of the second light guide plate 212 corresponding to the second edge of the second light guide plate 212, may be inclined with respect to a surface parallel with the thickness direction of the light guide unit 210. For this reason, a cross section of the light guide unit 210 parallel with the thickness direction of the light guide unit 210 may have a reversed trapezoid shape, more specifically, a reversed isosceles trapezoid shape. Thus, an upper surface of the light guide unit 210 may be larger in a planar area than a lower surface thereof.

A portion of light (hereinafter, referred to as a first light) supplied to the first light guide plate 211 from the light source unit 220 adjacent to the first edge of the first light guide plate 211 may be propagated to the second light guide plate 212 by total reflection within the first light guide plate 211, and may be refracted by a surface of the second light guide plate 212 to be output to outside the light guide unit 210. The remainder of the first light may be reflected at the reflection sheet 250 to be propagated to the second light guide plate 212, or may be refracted by a surface of the second light guide plate 212 to be output to the outside. Herein, the first lights output from points D1 to D7 on the surface of the second light guide plate 212 may be in parallel.

Most of the light (hereinafter, referred to as a second light) supplied to the second light guide plate 212 from the light source unit 220 adjacent to the second edge of the second light guide plate 212 may be total reflected within the second light guide plate 212, and the total reflected light may be refracted by a surface of the second light guide plate 212 to be output to the outside.

A portion of the second light may be propagated into the first light guide plate 211, and may be total reflected with the first light guide plate 211 or reflected at the reflection sheet 250 so as to be again propagated into the second light guide plate 212. The propagated light may be refracted at a surface of the second light guide plate 212 to be output to the outside. Herein, the second lights output from the points D1 to D7 on the surface of the second light guide plate 212 may be in parallel.

A light supplied to the first light guide plate 211 from the light source unit 220 may be in part propagated to the second light guide plate 212 by total reflection, and the partially propagated light may be refracted by a surface of the second light guide plate 212 to be output to the outside. The remaining of the light supplied to the first light guide plate 211 may be reflected by a reflection sheet 250, and the reflected light may be propagated to the second light guide plate 212 to be output to the outside.

The first lights and the second lights may have a first tilt angle φ and a second tilt angle φ′ inclined with respect to a virtual line that is perpendicular to an upper (or exit) surface of the second light guide plate 212. Also, the first tilt angle φ and the second tilt angle φ′ may be symmetrical with respect to a direction perpendicular to the upper surface of the second light guide plate 212. Herein, the first tilt angle φ may be an angle of a clockwise rotation with respect to a virtual line perpendicular to the upper surface of the second light guide plate 212, and the second tilt angle φ′ may be an angle of a counter clockwise rotation with respect to a virtual line perpendicular to the upper surface of the second light guide plate 212. In one exemplary embodiment, the first tilt angle φ and the second tilt angle φ′ may have a range of about 70 degrees (°) to about 89°.

The exemplary embodiment of the display device and the tilt angles described above may enable a light supplied to a display panel 100 from a backlight unit 200 to display a 3D image. In detail, the first light may be supplied to either one of a left eye and a right eye of a viewer, for example, the left eye, and the second light may be supplied to a remaining one of a left eye and a right eye of the viewer, for example, the right eye. Thus, an exemplary embodiment of a display device according to the invention may supply a light to be divided into a left eye and a right eye using the backlight unit 200. Therefore, the viewer sees a 3D image without a separate device such as the polarization glasses.

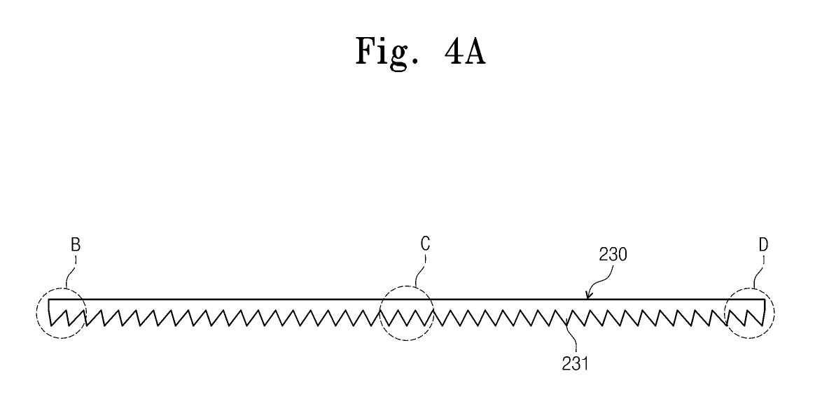

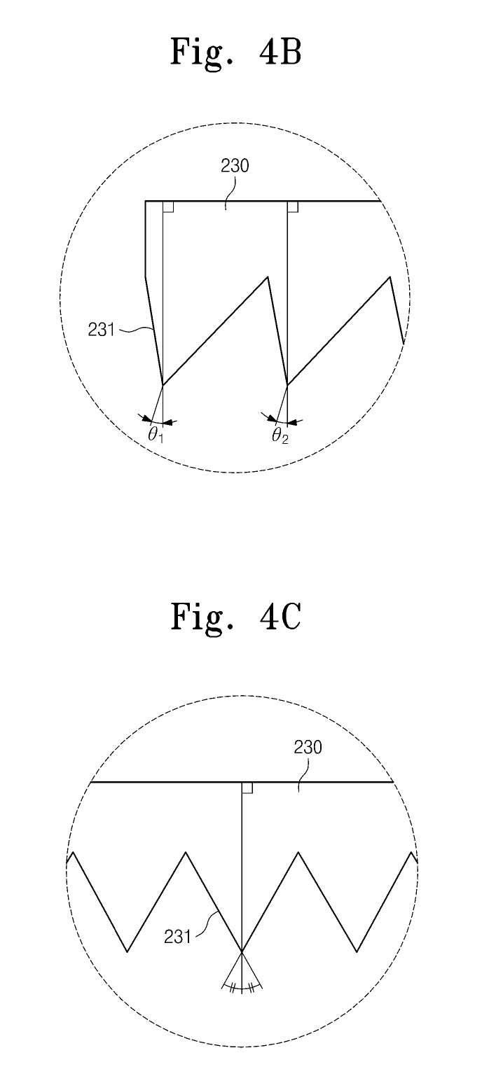

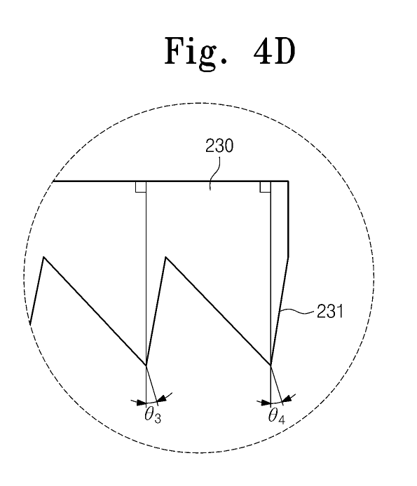

FIG. 4A is a cross-sectional view of an exemplary embodiment of a prism sheet illustrated in FIG. 1, and FIGS. 4B through 4D are enlarged diagrams of regions B, C, and D in FIG. 4A, respectively.

Referring to FIGS. 4A through 4D, apex angles of respective prisms 231 of a prism sheet 230 may be equal to one another. Each prism 231 includes two sides extending from a base, and the apex angle is defined by the two sides, where the two sides meet each other.

Angles θ1 and θ4 are defined at outermost prisms 231 of the prism sheet 230 closest to the light source units 220, where angles θ2 and θ3 are defined at prisms 231 between the outermost prisms 231 and a center of the prism sheet 230. Angles θ1 and θ4 may be larger than angles θ2 and θ3. Herein, each of the angles θ1 and θ4 may be an angle between a virtual line bisecting an apex angle of a prism 231 closest to a corresponding light source unit 220 and a virtual line parallel with the thickness direction of the prism sheet 230. Each of the angles θ2 and θ3 may be an angle between a virtual line bisecting an apex angle of a prism 231 located in a direction of a point half a distance between the light source units 220 (or, directly adjacent to a prism 231 having the angle θ1/θ4) and a virtual line parallel with the thickness direction of the prism sheet 230. That is, an angle between a virtual line bisecting an apex angle of each prism 231 and a virtual line parallel with the thickness direction of the prism sheet 230 may become larger as a prism is closer to the light source unit 220 with respect to a point of half a distance between the light source units 220, that is, at the center of the prism sheet 230.

Referring to FIG. 4C, a virtual line bisecting an apex angle of prisms 231 at the center of the prims sheet 230 is substantially the same as a virtual line parallel with the thickness direction of the prism sheet 230.

An angle between a virtual line bisecting an apex angle of each prism 231 and a virtual line parallel with a thickness direction of the prism sheet 230 may be symmetrical with respect to a point of half a distance between the light source units 220. This may be to enable the prism sheet 230 to refract a light from the light guide unit 210 in an angle corresponding to the binocular disparity.

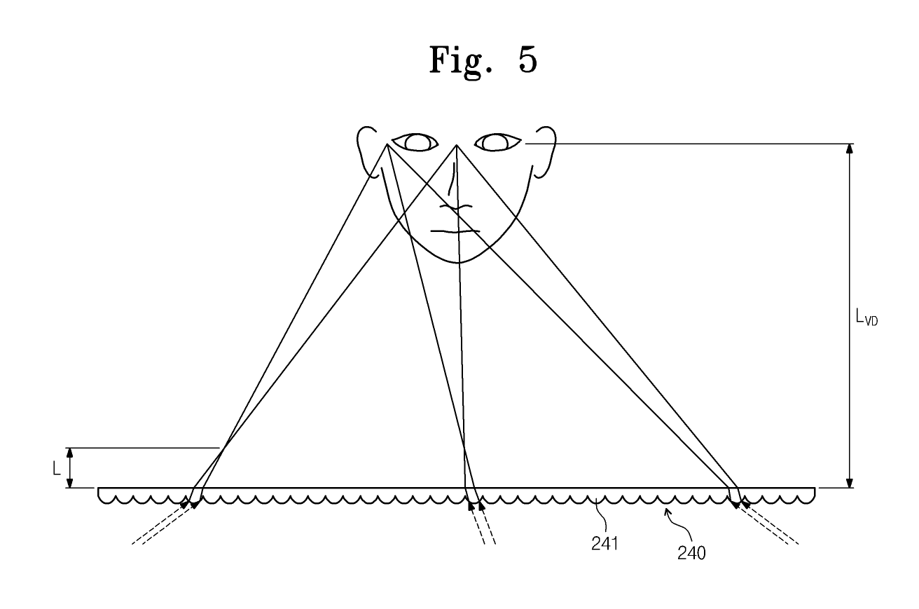

FIG. 5 is a cross-sectional view of an exemplary embodiment of a lens sheet illustrated in FIG. 1.

Referring to FIG. 5, a lens sheet 240 may include a surface (hereinafter, referred to as a first surface) facing the prism sheet and a surface (hereinafter, referred to as a second surface) opposite to the first surface. The lens sheet 240 may further include a plurality of lenses 241 which are placed on one (e.g., the first surface) of the first and second surfaces. The lenses 241 may have a longitudinal axis which extends parallel to the light source unit 220. The lenses 241 may be arranged from one edge of the lens sheet 240 adjacent to a light source unit 220, to the opposing edge thereof adjacent to another light source unit 220.

The lens sheet 240 may diffuse a light at an entire eye area since the focusing distance L of lenses of the lens sheet 240 is shorter than a viewing distance L_{VD} of a viewer. That is, since a 3D image supplied from the display device is diffused at the entire eye area of the viewer, a viewing range of the viewer may be widened.

Herein, a distribution distance A of a light, which is diffused at the entire eye area of the viewer and passes through the lens sheet 240, may be expressed by the following Equation 1.

$$A = \frac{P ( {L}_{VD} - L )}{L} \qquad ( 1 )$$

In the Equation 1, P may indicate a pitch between lenses 241, L may indicate a focusing distance of the lens 241, and L_{VD} may indicate a viewing distance of a viewer. In an exemplary embodiment, a pitch between the lenses 241 may be equal to or less than one third of a width of one pixel of a display panel 100.

Thus, a light incident onto a point of the lens sheet 240 far from a point half a distance between light source units 220 may progress toward a midpoint between the eyes of the viewer. Further, a light incident onto a point of the lens sheet 240 closer to a point half a distance between light source units 220 may progress toward the outside of both eyes of the viewer.

A light passing through the lens sheet 240 may be distributed at the entire eye area of the viewer, for example, between and toward an outside of the eye, and not focused at the eyes of the viewer. Thus, although the light or the image does not exist at a specific location, the viewer may see a 3D image.

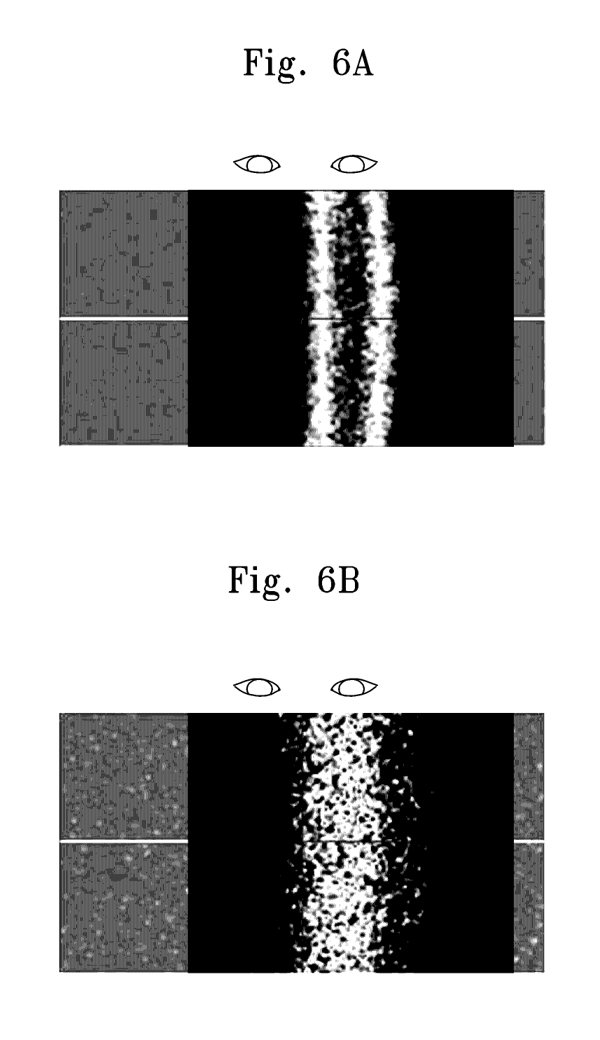

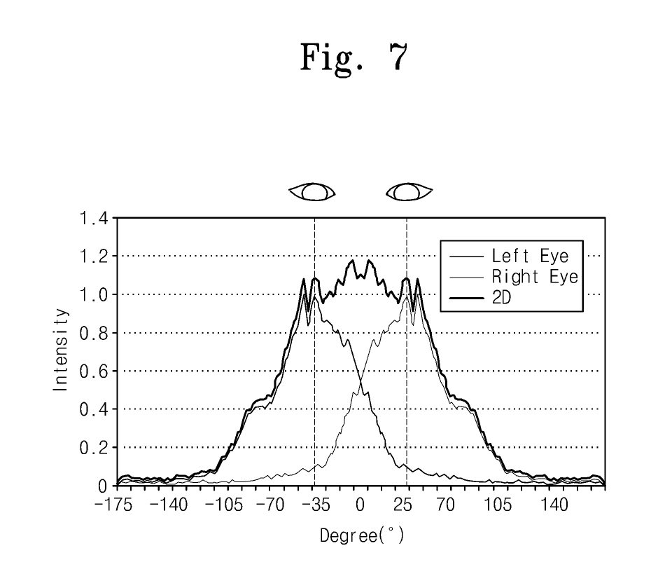

FIG. 6A is a diagram illustrating a distribution of a light passing through a prism sheet of a display device in FIG. 1, and FIG. 6B is a diagram illustrating a distribution of a light passing through a prism sheet and a lens sheet of a display device in FIG. 1. FIG. 7 is a graph illustrating a distribution of a light passing through a lens sheet of a display device in FIG. 1.

Referring to FIGS. 6A, 6B, and 7, when one of the light source units 220, for example, a light source unit 220 for a left eye is powered, a light passing through a prism sheet 230 may be focused at a narrow range of the entire eye area of a viewer.

If the light source unit 220 for the left eye is powered, a light passing through the prism sheet 230 and a lens sheet 240 may be focused at a wider range of the entire eye area of the viewer compared with that passing only through the prism sheet 230. Further, as illustrated in FIG. 7, all lights for a left eye and a right eye may be distributed at the entire eye area with high intensity.

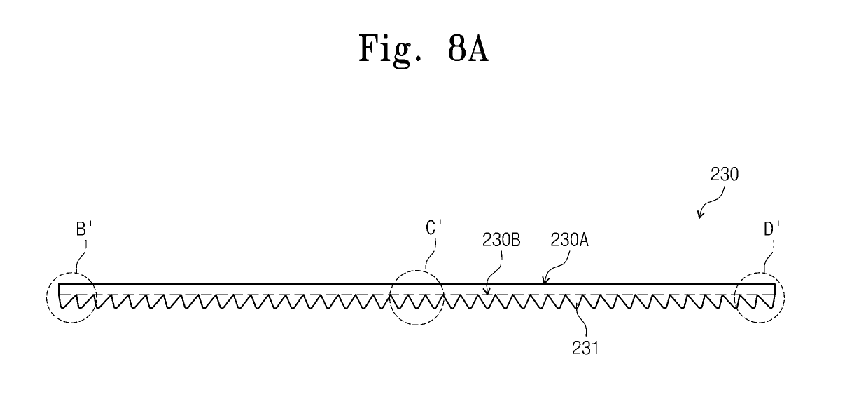

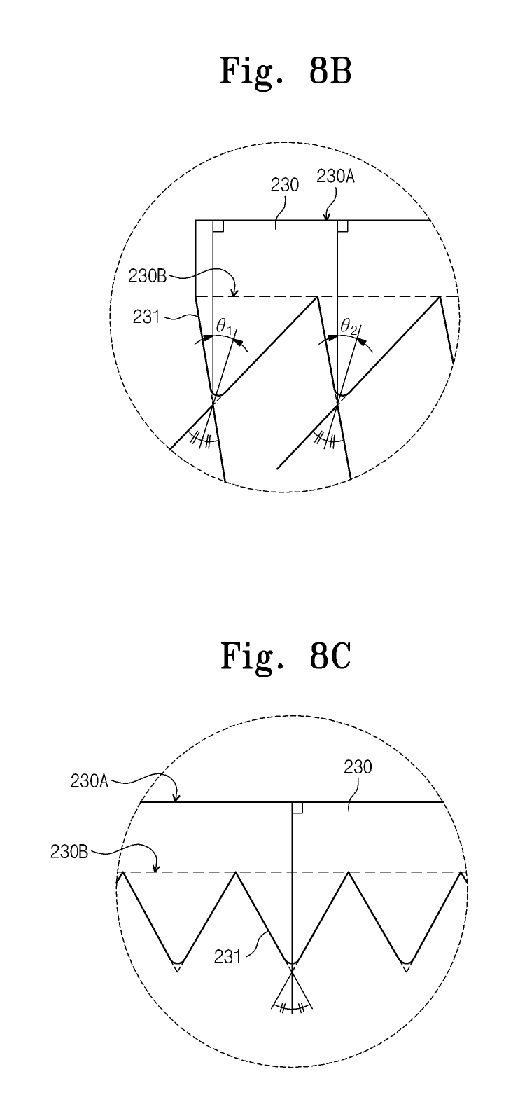

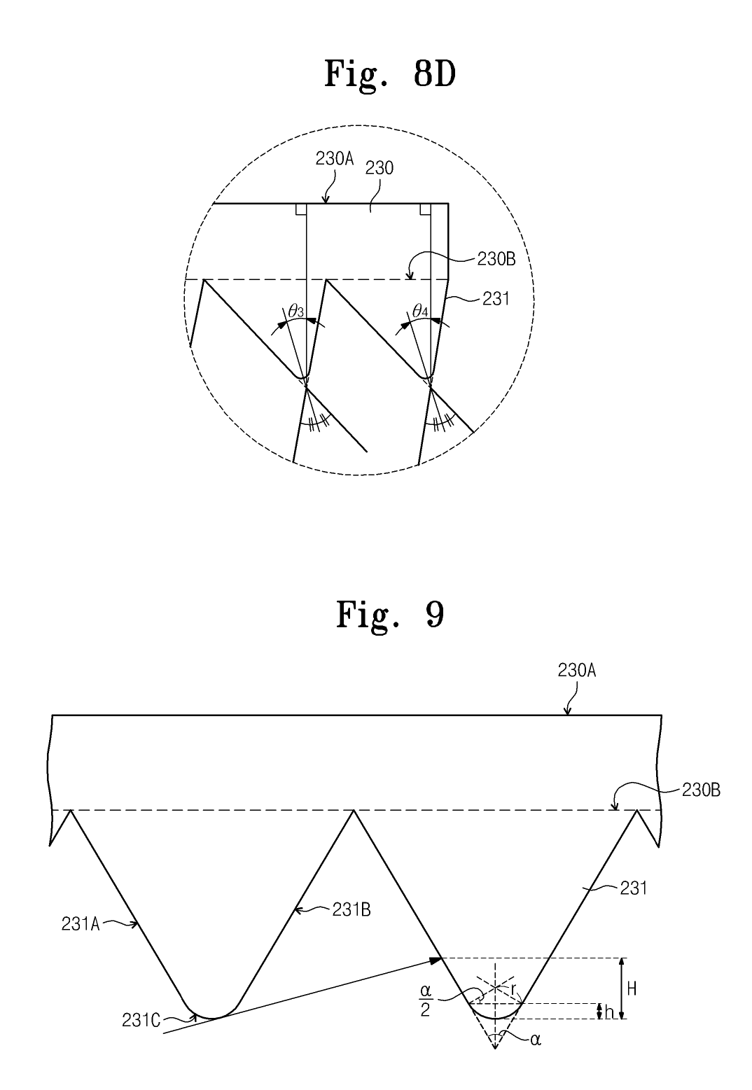

Below, other exemplary embodiments of the invention will be described with reference to FIGS. 8A to 21. In FIGS. 8A to 21, elements that are substantially similar or identical to those in FIGS. 1 to 7 may be marked by the same reference numerals, and description thereof is thus omitted.

FIG. 8A is a cross-sectional view of another exemplary embodiment of a prism sheet applicable to a display device in FIG. 1 according to the invention. FIGS. 8B to 8D are enlarged diagrams of regions B′, C′, and D′ in FIG. 8A, respectively. FIG. 9 is a diagram illustrating an exemplary embodiment of a shape of a prism of the prism sheet illustrated in FIGS. 8A to 8D.

Referring to FIGS. 8A to 8D and 9, a prism sheet 230 may have an upper surface 230A and a lower surface 230B. The lower surface 230B is coplanar with bases of the prisms 231. A plurality of prisms 231 may be provided on the lower surface 230B. Herein, the upper surface 230A may be a surface facing a lens sheet 240 in FIG. 1, and the lower surface 230B may be a surface facing a light guide unit 210 in FIG. 1. Also, each prism 231 may have a longitudinal axis that extends parallel to a light source unit 220, and the prisms 231 may be arranged from one edge of the prism sheet 230 adjacent to a light source unit 220, to the opposing edge thereof adjacent to another light source unit 220.

Each prism 231 may include a first tilt surface 231A extended from the lower surface 230B in a direction inclined with respect to a direction perpendicular to the lower surface 230B, a second tilt surface 231B extended from the lower surface 230B in a direction crossing a virtual line extended from the first tilt surface 231A, and a connection surface 231C connecting the first tilt surface 231A and the second tilt surface 231B to each other.

A distance between the lower surface 230B and a point at which the first tilt surface 231A and the connection surface 231C meet may be equal to a distance between the lower surface 230B and a point at which the second tilt surface 231B and the connection surface 231C meet.

The connection surface 231C may be a curved surface. That is, a distance between a point of the connection surface 231C and the lower surface 230B may be longer than a distance between the lower surface 230B and a point at which the first tilt surface 231A and the connection surface 231C meet.

The radius of curvature of the connection surface 231C may satisfy the following Equation 2.

$$r = h / ( 1 - sin \frac{α}{2} ) \qquad ( 2 )$$

In the Equation 2, h may be a difference between a maximum distance between the connection surface 231C and the lower surface 230B (e.g., at a distal end of the prism 231) and a maximum distance between the first or second tilt surface 231A or 231B, and the lower surface 230B. a may be an angle (hereinafter, referred to as a apex angle) formed by a virtual line extended from the first tilt surface 231A and a virtual line extended from the second tilt surface 231B.

The prisms 231 of the prism sheet 230 may have the same apex angle. Also, from among the prisms 231 of the prism sheet 230, a virtual line bisecting the apex angle may be perpendicular to the upper surface 230A of the prism sheet 230, at a prism, located half a distance between edges of the prism sheet 230 adjacent to light source units 220.

An angle between a virtual line bisecting an apex angle of each prism and a virtual line parallel with a thickness direction of the prism sheet becomes larger as the prism is positioned closer to the light source unit 220 with respect to the point of the prism sheet 230 half a distance between the light source units 220.

Angles θ1 and θ4 may be larger than angles θ2 and θ3. Herein, each of the angles θ1 and θ4 may be an angle between a virtual line bisecting an apex angle of a prism 231 closest to a corresponding light source unit 220 and a virtual line perpendicular to the upper surface 230A of the prism sheet 230. From among the prisms 231, each of the angles θ2 and θ3 may be an angle between a virtual line bisecting an apex angle of a prism 231 located in a direction toward a point of the prism sheet 230 half a distance between the light source units 230 and a virtual line perpendicular to the upper surface 230A of the prism sheet 230.

That is, an angle formed by a virtual line bisecting an apex angle of each prism 231 and a virtual line perpendicular to the upper surface 230A of the prism sheet 230 may become larger as a prism is closer to the light source units 220 with respect to a point of the prism sheet 230 half a distance between edges of the prism sheet 230 adjacent to the light source units 220.

Referring to FIG. 8C, a virtual line bisecting an apex angle of prisms 231 at the center of the prims sheet 230 is substantially the same as a virtual line perpendicular to the upper surface 230A of the prism sheet 230.

Also, an angle formed by a virtual line bisecting an apex angle of each prism 231 and a virtual line perpendicular to the upper surface 230A of the prism sheet 230 may be distributed symmetrically with respect to a point of the prism sheet 230 half a distance between edges of the prism sheet 230 adjacent to the light source units 220.

The exemplary embodiment of the display device of the invention may be configured such that an output light is dispersed through the prisms 231 each having the first tilt surface 231A, the second tilt surface 231B and the connection surface 231C. In particular, since a light output from the display device is dispersed after being incident onto the connection surface 231 C, the exemplary embodiment of the display device of the invention may provide a wider viewing angle compared with an exemplary embodiment of a display device including prisms each having only the first tilt surface 231A and the second tilt surface 231B.

A ratio of the amount of light output from the light guide unit 210 and incident onto the prism sheet 230, to the amount light output from the light guide unit 210 and incident onto the connection surface 231C, may satisfy the following Equation 3.

$$p = \frac{h}{H} \qquad ( 3 )$$

In the Equation 3, H may indicate a difference between first and second maximum distances, the first maximum distance being a distance between the connection surface 231C and the lower surface 230B and the second maximum distance being a distance between the lower surface 230B and a region where a light output from a light guide unit 210 reaches the first tilt surface 231A or the second tilt surface 231B. That is, H may be a difference between a further protruded point of the connection surface 231C from the lower surface 230B, and a minimum height of a region where a light output from a light guide unit 210 reaches the first tilt surface 231A or the second tilt surface 231B. Also, p may indicate a ratio of H to h.

FIG. 10 is a diagram illustrating a light path with respect to the prism sheet illustrated in FIGS. 8A, 8B and 9.

Referring to FIG. 10, a path of light incident onto a first or second tilt surface 231A or 231B of each prism 231 may be different from a path of light incident onto a connection surface 231C.

In detail, lights incident onto the first or second tilt surface 231A or 231B may be refracted at the first or second tilt surface 231A or 231B to be incident into each prism 231. Herein, since the first and second tilt surface 231A and 231B may be planar, the lights may be refracted in parallel. A light incident into each prism 231 may be total reflected at the first or second tilt surface 231A or 231B to be output to the outside of the prism sheet 230. Thus, although lights incident into each prism 231 through the first or second tilt surface 231A or 231B are output to the outside, they may be parallel.

Lights incident onto the connection surface 231C may be refracted at the connection surface 231C to be incident into each prism 231. A light incident into each prism may be total reflected at the first or second tilt surface 231A or 231B to be output to the outside of the prism sheet 230. Herein, since the connection surface 231C is a curved surface, refracted lights may not be parallel, and may proceed in different directions. Thus, lights incident into each prism through the connection surface 231C and output to the outside may not be parallel. That is, lights incident into each prism through the connection surface 231C may be dispersed to be output to the outside.

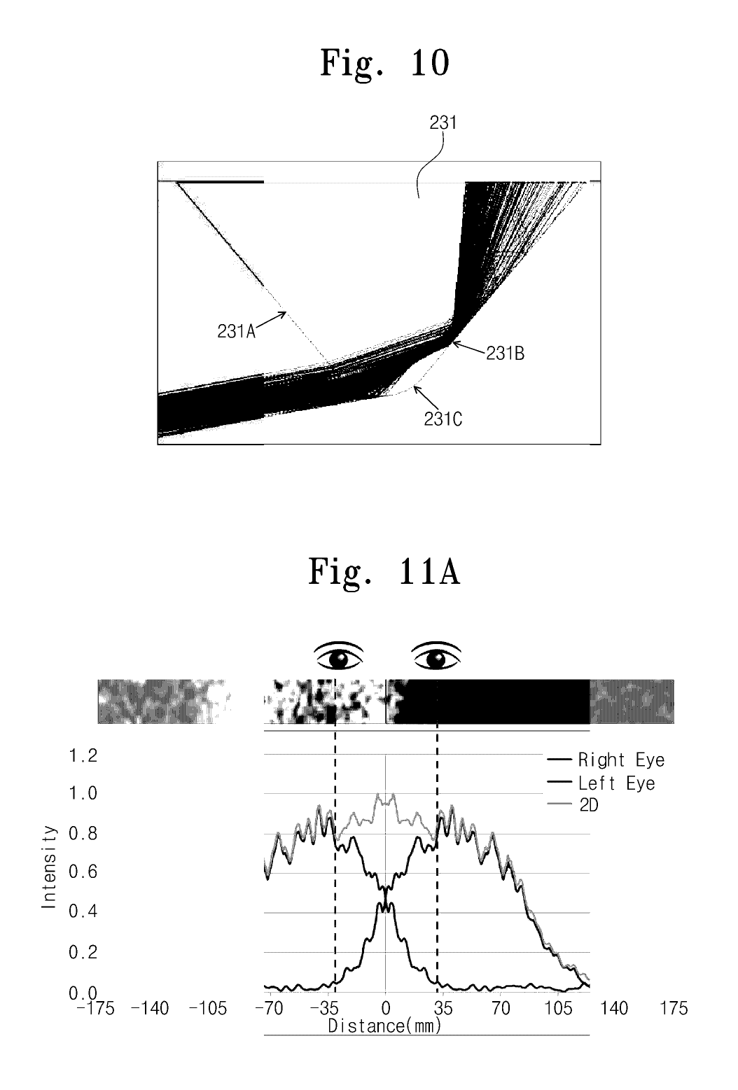

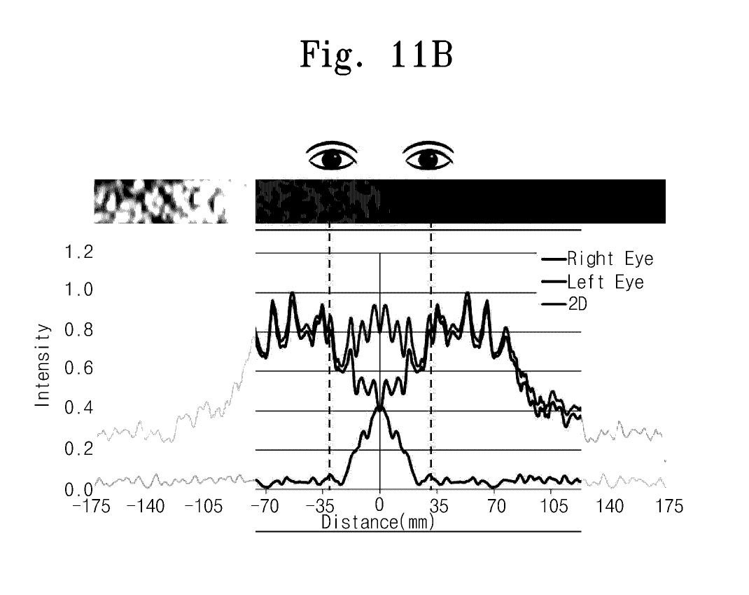

FIG. 11A is a graph of intensity versus distance in millimeters (mm) with respect to eyes of a viewer, illustrating a distribution of lights which are output from a display device having a prism sheet in FIGS. 4A to 4D and reach a viewing distance. FIG. 11B is a graph illustrating a distribution of lights which are output from a display device having a prism sheet in FIGS. 8A to 8D and 9 and reach a viewing distance.

Referring to FIGS. 11A and 11B, lights output from a display device having a prism sheet in FIGS. 8A to 8D and 9 may be distributed at a wider area at a viewing distance compared with lights output from a display device having a prism sheet in FIGS. 4A to 4D.

The reason may be that when a prism has a first tilt surface 231A, a second tilt surface 231B and a connection surface 231C, a light incident onto the connection surface 231C is refracted in a direction different from a light incident onto the first and second tilt surfaces 231A and 231B to be provided to a viewer.

Thus, the an exemplary embodiment of a display device of the invention having a prism sheet including prisms having a first tilt surface, a second tilt surface and a connection surface, may provide a wider viewing angle compared with a display device having a prism sheet including prisms each having only first and second tilt surfaces. In particular, the exemplary embodiment of display device of the invention may provide a wider viewing angle for displaying of a planar image, rather than for displaying of a 3D image.

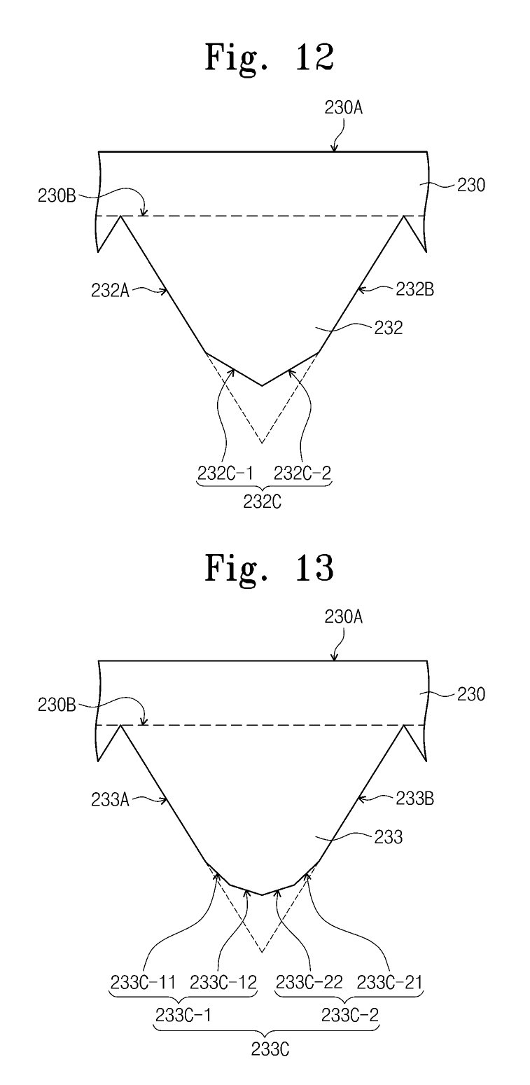

FIGS. 12 to 15 are cross-sectional views of alternative exemplary embodiment of prisms of the prism sheet in FIGS. 8A to 8D and 9 according to the invention concept.

Referring to FIGS. 12 to 15, a prism 232 of a prism sheet 230 may include a first tilt surface 232A, a second tilt surface 232B, and a connection surface 232C connecting the first and second tilt surfaces 232A and 232B to each other. A prism 233 may include a first tilt surface 233A, a second tilt surface 233B, and a connection surface 233C connecting the first and second tilt surfaces 233A and 233B to each other. A prism 234 may include a first tilt surface 234A, a second tilt surface 234B, and a connection surface 234C connecting the first and second tilt surfaces 234A and 234B to each other. A prism 235 may include a first tilt surface 235A, a second tilt surface 235B, and a connection surface 235C connecting the first and second tilt surfaces 235A and 235B to each other.

The connection surface 232C of the prism 232 in FIG. 12 may include a plurality of tilt surfaces. As shown in FIG. 12, for example, the collectively connection surface 232C may include a third tilt surface 232C-1 connected with the first tilt surface 232A, and a fourth tilt surface 232C-2 connected with the second and third tilt surfaces 232B and 232C-1. Herein, a first distance between a connection point of the third and fourth tilt surfaces 232C-1 and 232C-2 and the lower surface 230B, may be larger than a second distance between a respective connection point of the second and connection surfaces 232B and 232C and the third and fourth tilt surfaces 232C-1 and 232C-2, and the lower surface 230B.

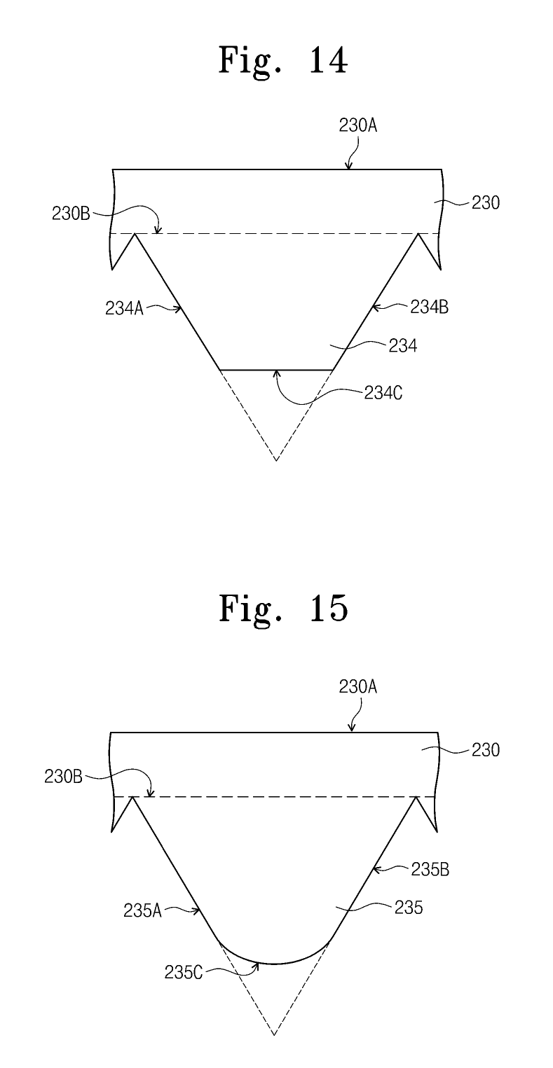

The connection surface 233C of the prism 233 in FIG. 13 may include a plurality of tilt surfaces 233C-1 and 233C-2, each of which has a plurality of sub tilt surfaces.

As shown in FIG. 13, for example, the collective connection surface 233C may include third and fourth tilt surfaces 233C-1 and 233C-2. The collective third tilt surface 233C-1 may include first and second sub tilt surfaces 233C-11 and 233C-12, and the collective fourth tilt surface 233C-2 may include third and fourth sub tilt surfaces 233C-21 and 233C-22. The first sub tilt surfaces 233C-11 may connect the first tilt surface 233A and the second sub tilt surface 233C-12 to each other, and the third sub tilt surfaces 233C-21 may connect the second tilt surface 233B and the fourth sub tilt surface 233C-22 to each other. The third sub tilt surface 233C-21 and the fourth sub tilt surface 233C-22 may be interconnected.

An angle formed by a surface parallel with the first sub tilt surfaces 233C-11 and the third sub tilt surfaces 233C-21, and the lower surface 230B of the prism sheet 230 may be larger than an angle formed by a surface parallel with the second sub tilt surfaces 233C-12, and the fourth sub tilt surfaces 233C-22 and the lower surface 230B.

In FIG. 13, it is illustrated that tilt surfaces 233C-1 and 233C-2 of the connection surface 233C have two sub tilt surfaces (233C-11 and 233C-12) and (233C-21 and 233C-22), respectively. However, the invention is not limited thereto. In one or more alternative exemplary embodiments, for example, each of the tilt surfaces 233C-1 and 233C-2 may include three or more sub tilt surfaces.

The connection surface 234C of the prism 234 in FIG. 14 may be a surface that connects the first tilt surface 234A and the second tilt surface 234B to each other, and is substantially linear and parallel with the lower surface 230B.

The connection surface 235C of the prism 235 in FIG. 15 may connect a first tilt surface 235A and a second tilt surface 235B to each other. Herein, the connection surface 235C may be a curved surface, a part of an ellipse or a free curve.

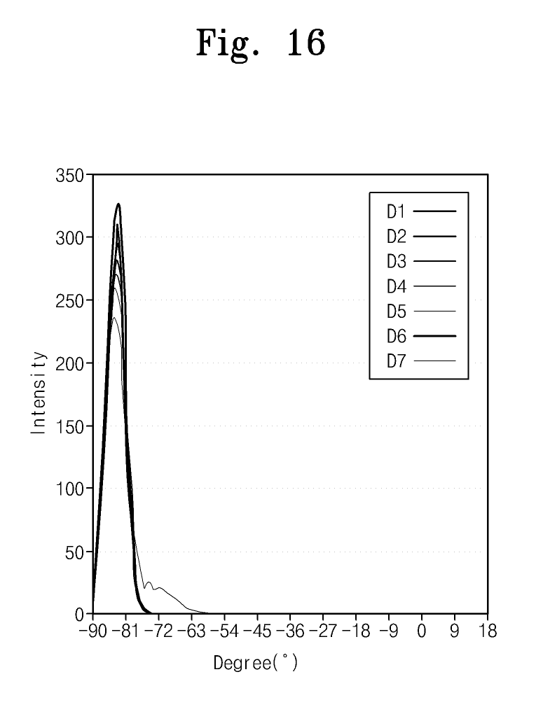

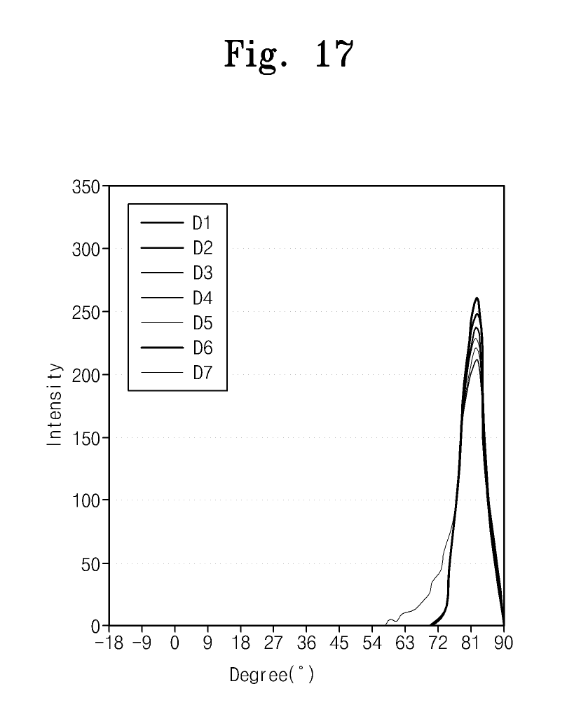

FIG. 16 is a graph of intensity versus a degrees (°), illustrating a distribution of lights output from each point of a light guide unit in FIG. 3 to be provided to a right eye of a viewer. FIG. 17 is a graph of intensity versus a degrees (°), illustrating a distribution of lights output from each point of a light guide unit in FIG. 3 to be provided to a left eye of a viewer.

Referring to FIGS. 16 and 17, characteristics of first lights may be different from characteristics of second lights.

In detail, the first lights may have a first tilt angle φ with respect to a virtual line perpendicular to an exit surface of a second light guide plate 212, and the second lights may have a second tilt angle φ′ with respect to a virtual line perpendicular to the exit surface of the second light guide plate 212. The first tilt angle φ and the second tilt angle φ′ may be different from each other. As illustrated in FIG. 16, the first light may have the first tilt angle φ of a range of about 74° to 89°. A half-width of the first light may be about 6°. Also, as illustrated in FIG. 17, the second light may have the second tilt angle φ′ of a range of about 70° to 89°. A half-width of the second light may be about 3°.

That is, a tilt angle and a half-width of the first light output from an exit surface of the second light guide plate 212 may be different those of the second light. In particular, in the event that a display device displays a 3D image, a light corresponding to a left-eye image and a light corresponding to a right-eye image may be uniformly provided to a viewer due to a difference between tilt angles of the first and second lights output from the exit surface of the second light guide plate 212.

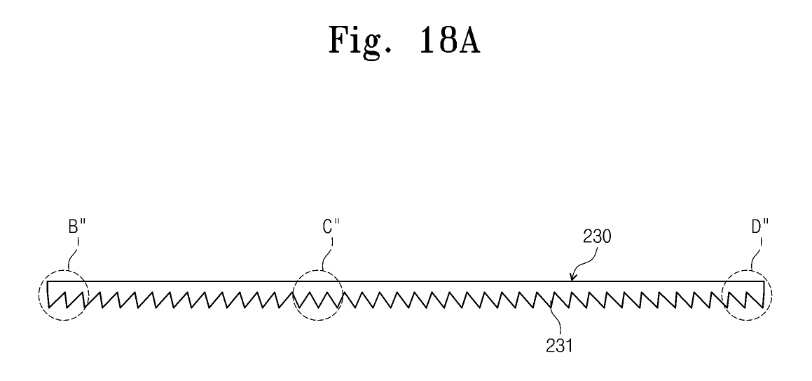

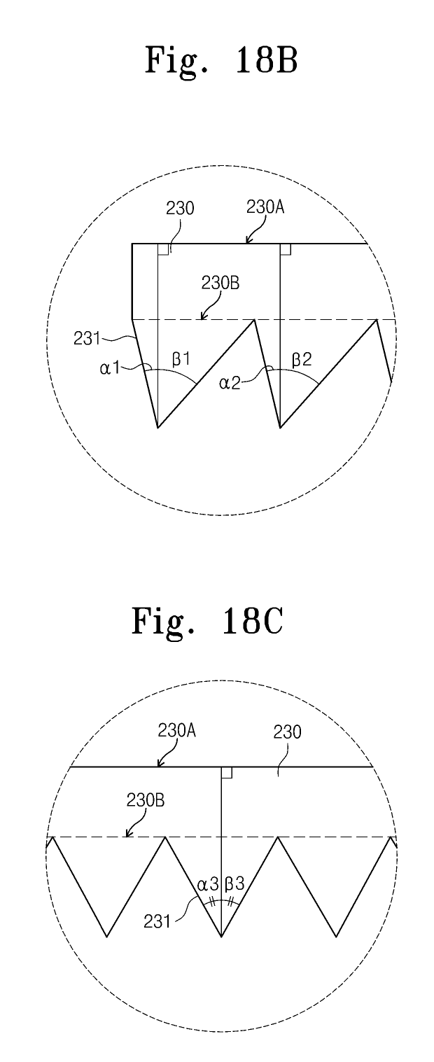

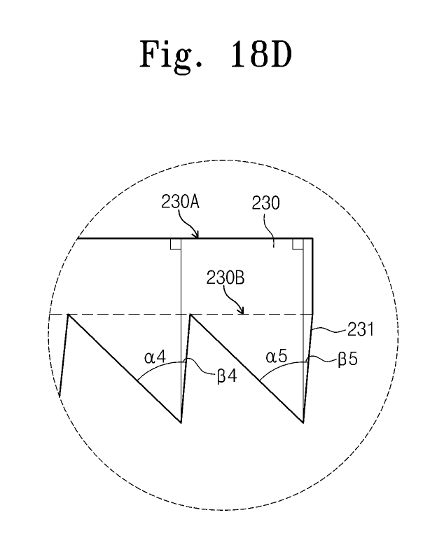

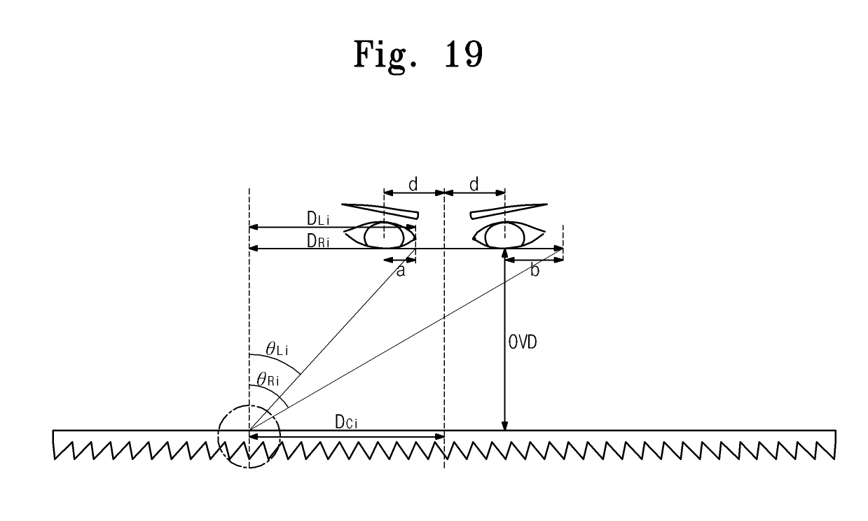

FIG. 18A is a cross-sectional view of still another exemplary embodiment of a prism sheet applicable to a display device in FIG. 1 according to the invention. FIGS. 18B to 18D are enlarged views of region B″, C″, and D″ in FIG. 18A, respectively. FIG. 19 is a conceptual view illustrating a prism of which a virtual line perpendicular to an upper surface of a prism sheet bisects the apex angle of the prism, is spaced apart from a point of the prism sheet corresponding to half a distance between edges of the prism sheet respectively adjacent to light source units.

Referring to FIGS. 18A to 18D and 19, a prism sheet 230 may have an upper surface 230A and a lower surface 230B, and a plurality of prisms 231 may be provided on the lower surface 230B. Herein, the upper surface 230A may be a surface facing a lens sheet 240 in FIG. 1, and the lower surface 230B may be a surface facing a light guide unit 210 in FIG. 1. Each prism 231 may have a longitudinal axis which extends parallel to the longitudinal axis of the printed circuit board 222. Also, the prisms 231 may be arranged from one edge of the prism sheet 230 adjacent to a light source unit 220, to the opposing edge thereof adjacent to another light source unit 220.

Each of the prisms 231 may have a first tilt surface 231A extended from the lower surface 230B in a direction inclined with respect to a direction perpendicular to the upper surface 230A or the lower surface 230B, and a second tilt surface 231B meeting the the first tilt surface 231A and extended from the lower surface 230B. Herein, in each prism 231, the first tilt surface 231A may be a tilt surface of a first edge direction, and the second tilt surface 231B may be a tilt surface of a second edge direction. An angle formed by the first tilt surface 231A and the second tilt surface 231B may be an apex angle of each prism 231, and the prisms 231 may have the same apex angle.

It is assumed that an angle formed by the first tilt surface 231A, and a virtual line passing through an intersecting point of the first tilt surface 231A and the second tilt surface 231B and perpendicular to the upper surface 230A, is a third tilt angle αn. Also, it is assumed that an angle formed by the virtual line passing through an intersecting point of the first tilt surface 231A and the second tilt surface 231B and perpendicular to the upper surface 230A, and the second tilt surface 231B is a fourth tilt angle βn.

In one of the prisms 231, for example, a prism 231 proximate to a first edge of the light guide unit 210 (e.g., region B″), the third tilt angle α1 may be smaller than the fourth tilt angle β1.

The third tilt angle α1 of a prism 231 proximate to the first edge of the light guide unit 210 may be smaller than the third tilt angle α2 of a prism 231 located further away from the first edge and in a direction toward a second edge of the light guide unit 210. On the other hand, the fourth tilt angle β1 of a prism 231 proximate to the first edge of the light guide unit 210 may be larger than the fourth tilt angle β2 of a prism 231 located further away from the first edge and in a direction toward a second edge of the light guide unit 210.

In a prism 231 proximate to a second edge of the light guide unit 210 (e.g., region D″), the third tilt angle α5 may be larger than the fourth tilt angle β5.

The third tilt angle α5 of a prism 231 proximate to the second edge of the light guide unit 210 may be larger than the third tilt angle α4 of a prism 231 located further away from the second edge and in a direction toward a first edge of the light guide unit 210. On the other hand, the fourth tilt angle β5 of a prism 231 proximate to the second edge of the light guide unit 210 may be smaller than the fourth tilt angle β4 of a prism 231 located further away from the second edge and in a direction toward the first edge of the light guide unit 210.

The third tilt angle α1 of a prism 231 proximate to the first edge of the light guide unit 210 (e.g., region B″) may be larger than the fourth tilt angle β5 of a prism 231 proximate to the second edge of the light guide unit 210 (e.g., region D″).

In one of the prisms 231, the third tilt angle α3 may be equal to the fourth tilt angle β3 (e.g., region C″). That is, a virtual line passing through an intersecting point of the first tilt surface 231A and the second tilt surface 231B and perpendicular to the upper surface 230A may bisect an apex angle of the prism 231.

A prism of which the virtual line passing through an intersecting point of the first tilt surface 231A and the second tilt surface 231B and perpendicular to an upper surface of the prism sheet 230 bisects the apex angle of the prism, may be spaced apart from a point of the prism sheet 230 corresponding to half a distance between edges of the prism sheet 230 respectively adjacent to light source units 220. As illustrated in FIG. 18A, for example, the prism 231 of which the apex angle is bisected by a virtual line perpendicular to the upper surface 230A (e.g., region C″) may be located biased in a first edge direction of the light guide unit 200 from a point of the prism sheet 230 corresponding to half a distance between edges of the prism sheet 230 respectively adjacent to light source units 220.

Below, there will be described a manner of obtaining a distance D by which a prism of which the virtual line perpendicular to an upper surface of the prism sheet 230 bisects the apex angle of the prism, is spaced apart from a point of the prism sheet 230 corresponding to half a distance between edges of the prism sheet 230 respectively adjacent to light source units 220, under the following assumption.

Half a distance between centers of two eyes of a viewer is marked by d, and a prism proximate to a first edge of the light guide unit 210 is referred to as a first prism. A horizontal distance between an ith prism 231 and a point where a light output from the ith prism 231 reaches a left eye of a viewer, is marked by D_{Li}. A horizontal distance between the ith prism 231 and a point where a light output from the ith prism 231 reaches a right eye of the viewer is marked by D_{Ri}. A distance between the ith prism 231 and a center between two eyes of the viewer may be marked by D_{Ci}. An angle formed by a virtual line perpendicular to the upper surface 230A of the prism sheet and a virtual line connecting the ith prism 231 and a point where a light output from the ith prism 231 reaches the left eye of the viewer is marked by θ_{Li}. An angle formed by a virtual line perpendicular to the upper surface 230A of the prism sheet and a virtual line connecting the ith prism 231 and a point where a light output from the ith prism 231 reaches the right eye of a viewer is marked by θ_{Ri}. A vertical distance (hereinafter, referred to as an optimum viewing distance) between the viewer and the prism sheet 230 may be marked by OVD.

The following Equations 4 and 5 may indicate D_{Li} and D_{Ri}, respectively.

D_{Li}=OVD×tanθ_{Li} (4)

D_{Ri}=OVD×tanθ_{Ri} (5)

The following Equation 6 may indicate a distance ‘a’ spaced apart from a center of a left eye of the viewer in the event that a light output from the ith prism 231 is not provided to the center of the left eye of the viewer.

α=D_{Li}−(D_{Ci}−d) (6)

The following Equation 7 may indicate a distance ‘b’ spaced apart from a center of a right eye of the viewer in the event that a light output from the ith prism 231 is not provided to the center of the right eye of the viewer.

b=D_{Ri}−(D_{Ci}+d) (7)

Thus, the ith prism 231 may be shifted by a predetermined distance from a prism located at a point of the prism sheet 230 corresponding to half a distance between edges of the prism sheet 230 respectively adjacent to the light source units.

Herein, a shift distance Dpi of the ith prism 231 may correspond to an average of the horizontal distance ‘a’ and the horizontal distance ‘b’, and may be expressed by the following Equation 8.

$${D}_{pi} = \frac{a + b}{2} = \frac{{D}_{Li} + {D}_{Ri} - 2 {D}_{Ci}}{2} \qquad ( 8 )$$

The ith prism 231 may be defined by first and second distances. The first distance may be a distance between the ith prism 231 and a prism 231 of which the apex angle is bisected by a virtual line perpendicular to the upper surface 230A, and the second distance may be a distance between the ith prism 231 and a point of the prism sheet 230 corresponding to half a distance between edges of the prism sheet 230 respectively adjacent to the light source units 220.

Thus, a shift distance of a prism, of which the apex angle is bisected by a virtual line perpendicular to the upper surface 230A, from a point of the prism sheet 230 corresponding to half a distance between edges of the prism sheet 230 respectively adjacent to the light source units 220, may be an average of shift distances of all prisms 231.

The following Equation 9 may indicate a distance by which a prism of which the apex angle is bisected by a virtual line perpendicular to the upper surface 230A is spaced apart from a point of the prism sheet 230 corresponding to half a distance between edges of the prism sheet 230 respectively adjacent to the light source units 220 at the prism sheet 230.

$$D = \frac{{\sum }_{i = 1}^{i = M} {D}_{pi}}{M} \qquad ( 9 )$$

In the Equation 9, M may indicate the number of prisms.

Although an exemplary embodiment of a display device including the above-described prism sheet 230 displays a 3D image using a light provided from a light guide unit 210 in FIG. 3, it is possible to uniformly provide a light corresponding to a left-eye image and a light corresponding to a right-eye image to a viewer.

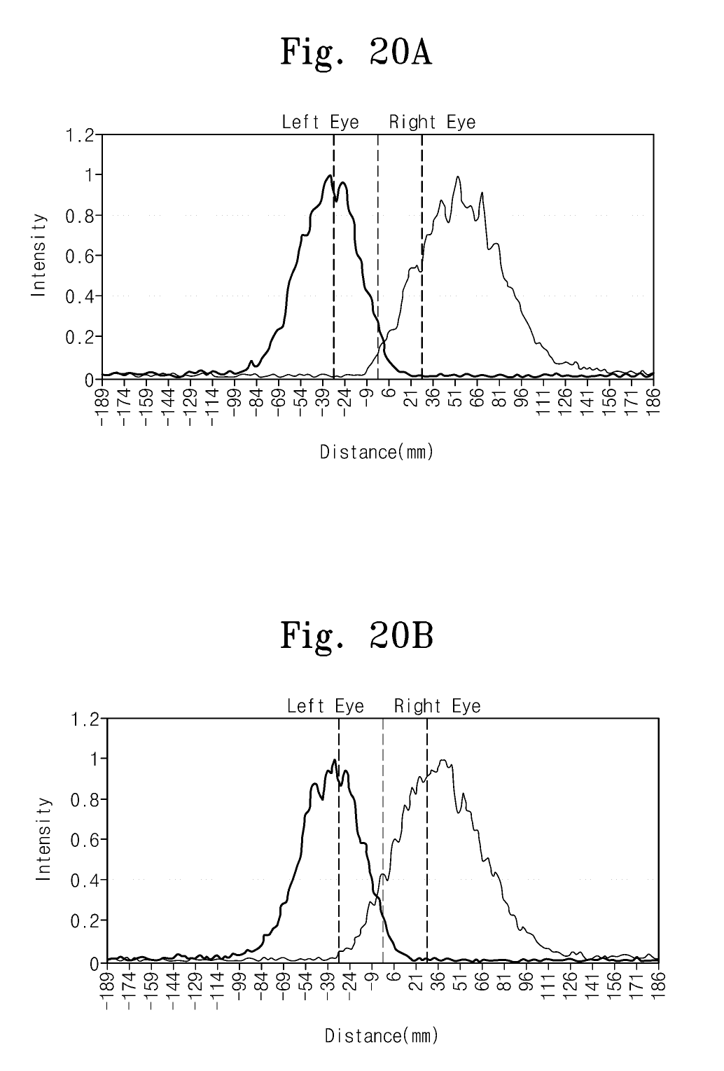

FIGS. 20A and 20B are graphs of intensity versus distance in mm, illustrating a distribution according to lights output from a backlight unit based on a location of a prism of which the apex angle is bisected by a virtual line perpendicular to an upper surface at a prism sheet. Distributions in FIGS. 20A and 20B may be based on the midpoint between two eyes of a viewer.

Herein, FIG. 20A shows the case that a display device includes a prism sheet where a prism of which the apex angle is bisected by a virtual line perpendicular to an upper surface of the prism sheet, is located at a point of the prism sheet corresponding to half a distance between edges of the prism sheet respectively adjacent to the light source units. FIG. 20B shows the case that a display device includes a prism sheet where a prism of which the apex angle is bisected by a virtual line perpendicular to an upper surface of the prism sheet is shifted by 30 mm toward in a left-eye side from a point of the prism sheet corresponding to half a distance between edges of the prism sheet respectively adjacent to the light source units. Intensity may be measured at a point where a distance from each prism sheet is 500 nanometers (nm).

Referring to FIG. 20A, in a backlight unit having a prism sheet where a prism of which the apex angle is bisected by a virtual line perpendicular to an upper surface of the prism sheet is located at a point of the prism sheet corresponding to half a distance between edges of the prism sheet respectively adjacent to the light source units at the prism sheet, a distribution of lights provided to a left eye of a viewer may be different from a distribution of lights provided to a right eye of the viewer.

In detail, in a backlight unit having a prism sheet where a prism of which the apex angle is bisected by a virtual line perpendicular to an upper surface of the prism sheet is located at a point of the prism sheet corresponding to half a distance between edges of the prism sheet respectively adjacent to the light source units (like in FIG. 8A), a light incident onto the left eye from the backlight may be distributed to correspond to a center of the left eye. But, in a backlight unit having a prism sheet where a prism of which the apex angle is bisected by a virtual line perpendicular to an upper surface of the prism sheet is located at a point of the prism sheet corresponding to half a distance between edges of the prism sheet respectively adjacent to the light source units, a light incident onto the right eye from the backlight may be distributed at the outside of the right eye, not focused on the center of the right eye.

Referring to FIG. 20B, in a backlight unit including a prism sheet where a prism of which the apex angle is bisected by a virtual line perpendicular to an upper surface of the prism sheet is shifted by 30 mm toward a left-eye side from a point of the prism sheet corresponding to half a distance between edges of the prism sheet respectively adjacent to the light source units (like in FIG. 18A), lights provided to left and right eyes of the viewer may be uniformly distributed at the left and right eyes compared with a backlight unit including a prism sheet in FIG. 8A.

As described above, although lights for left-eye and right-eye images output from a light guide unit 210 have different characteristics, a backlight unit including a prism sheet where prisms are shifted by a predetermined distance may provide lights to left and right eyes of a viewer uniformly.

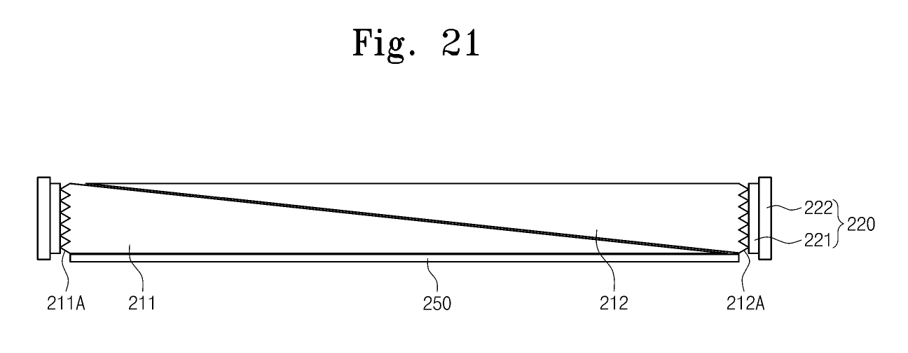

FIG. 21 is a cross-sectional view illustrating another exemplary embodiment of a backlight unit used in a display device according to the invention.

Referring to FIG. 21, light source units 220 may be disposed to be adjacent to a first edge and a second edge of a light guide unit 210. A plurality of prism patterns 211A and 212B may be disposed at lateral surfaces facing the light source units 220, respectively. That is, a plurality of prism patterns 211A and 212A may be disposed at an incident surface of a first light guide plate 211 and an incident surface of a second light guide plate 212. The prism patterns 211A and 211B may have a longitudinal axis which extends parallel to the light source units 220, and may be arranged in a direction from the exit surface of the second light guide plate 212 towards the reflection sheet 250.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A backlight unit comprising:
a light guide unit comprising a first edge, a second edge opposed to the first edge, and a light exiting surface which connects the first edge and the second edge;
light source units adjacent to the first and second edges of the light guide unit, respectively;
a prism sheet which faces the light exiting surface of the light guide unit, wherein the prism sheet comprises a plurality of prisms on a surface which faces the light guide unit, and a light exiting surface; and
a lens sheet which faces the light exiting surface of the prism sheet, wherein the lens sheet comprises a plurality of lenses which faces the prism sheet,
wherein
the light guide unit comprises a first light guide plate and a second light guide plate,
a thickness of a region of the first light guide plate adjacent to the first edge is greater than a thickness of a region of the first light guide plate adjacent to the second edge, and
a thickness of a region of the second light guide plate adjacent to the second edge is greater than a thickness of a region of the second light guide plate adjacent to the first edge.

2. The backlight unit of claim 1, wherein
an angle between a virtual line bisecting an apex angle of each prism and a virtual line parallel with a thickness direction of the prism sheet becomes larger as a prism is closer to the light source unit with respect to a center point of the prism sheet, and
the center point is half a distance between edges of the prism sheet, the edges of the prism sheet respectively adjacent to the light source units.

3. The backlight unit of claim 2, wherein an angle between the virtual line bisecting an apex angle of each prism and the virtual line parallel with a thickness direction of the prism sheet is symmetrical with respect to the center point of the prism sheet.

4. The backlight unit of claim 1, wherein apex angles of the prisms are equal to one another.

5. The backlight unit of claim 1, wherein
the lenses of the lens sheet are arranged in a direction from the first edge to the second edge of the light guide unit, and
a distribution distance A of a light which is diffused to an entire eye area of a viewer and passes through the lens sheet, is expressed by:
$$A = \frac{P ( {L}_{VD} - L )}{L}$$
wherein P indicates a pitch of the plurality of lenses, L indicates a focusing distance of the lens sheet, and L_{VD} indicates a viewing distance of the viewer.

6. The backlight unit of claim 1, wherein a light output from the light guide unit progresses in a direction of 75° through 89° with respect to a surface parallel with a thickness direction of the light guide unit.

7. The backlight unit of claim 1, wherein
a lateral surface of the first light guide plate corresponds to the first edge of the light guide unit, and
a lateral surface of the second light guide plate corresponds to the second edge of the light guide unit,
wherein the lateral surfaces are inclined with respect to the light exiting surface of the light guide unit.

8. The backlight unit of claim 7, wherein a cross section of the light guide unit, parallel with a thickness direction of the light guide unit, has a reversed trapezoid shape.

9. The backlight unit of claim 1, wherein
the prism sheet further comprises a lower surface opposing the light exiting surface thereof, and
each prism includes:
a first tilt surface which extends from the lower surface in a direction inclined with respect to a direction perpendicular to the lower surface;
a second tilt surface which extends from the lower surface in a direction which intersects with a virtual line of the first tilt surface; and
a connection surface which connects the first tilt surface and the second tilt surface.

10. The backlight unit of claim 9, wherein
an angle formed by a virtual line bisecting an apex angle of the each prism and a virtual line perpendicular to the lower surface of the prism sheet becomes larger as the prisms are closer to first and second edges of the prism sheet with respect to a center point of the prism sheet,
the first and second edges of the prism sheet respectively adjacent to the light source units, and the center point at half a distance between the first and second edges of the prism sheet, and
the apex angle formed by the first tilt surface, and a virtual line of the second tilt surface.

11. The backlight unit of claim 10, wherein a distance between the connection surface and the lower surface of the prism sheet, is larger than a distance between the lower surface of the prism sheet and a point at which the first or second tilt surface, and the connection surface meet.

12. The backlight unit of claim 11, wherein a radius of curvature of the connection surface is expressed by:
$$r = h / ( 1 - sin \frac{α}{2} )$$
wherein
h is a difference between a maximum distance between the connection surface and the lower surface of the prism sheet, and a maximum distance between the first or second tilt surface, and the lower surface, and
α is an angle corresponding to the apex angle.

13. The backlight unit of claim 12, wherein a ratio of an amount of light output from the light guide unit and incident onto the prism sheet, to an amount of light output from the light guide unit and incident onto the connection surface is expressed by:
$$p = \frac{h}{H}$$
wherein H indicates a difference between a maximum distance and a minimum distance, the maximum distance being a distance between the connection surface and the lower surface, and the minimum distance being a distance between the lower surface and a region where a light output from the light guide unit reaches the first tilt surface or the second tilt surface.

14. The backlight unit of claim 10, wherein the connection surface comprises:
a third tilt surface which is connected with the first tilt surface and comprises a sub tilt surface; and
a fourth tilt surface which connects the second and third tilt surfaces, and comprises a sub tilt surface.

15. The backlight unit of claim 14, wherein a distance between the lower surface and a connection point of the third and fourth tilt surfaces is greater than a distance between the lower surface and a connection point of the first and third tilt surfaces or a connection point of the second and fourth tilt surfaces.

16. The backlight unit of claim 15, wherein
the third tilt surface comprises a first sub tilt surface and a second sub tilt surface, and
the fourth tilt surface includes a third sub tilt surface and a fourth sub tilt surface,
the first sub tilt surface connecting the first tilt surface and the second sub tilt surface, the third sub tilt surface connecting the second tilt surface and the fourth sub tilt surface, and the second and fourth sub tilt surfaces meeting at the connection point of the second and fourth tilt surfaces.

17. The backlight unit of claim 1,
the prism sheet further comprises a lower surface opposing the light exiting surface thereof;
wherein each of the prisms includes a first tilt surface which is connected to the lower surface, and a second tilt surface which intersects the first tilt surface and is connected to the lower surface, and
wherein a prism of which an apex angle is bisected by a virtual line perpendicular to the lower surface and passing through an intersected point of the first and second tilt surfaces, is spaced apart from a center point of the prism sheet,
the center point at half a distance between edges of the prism sheet, the edges of the prism sheet respectively adjacent to the light source units, and the apex angle formed by the first and second tilt surfaces.

18. The backlight unit of claim 17, wherein a distance between a prism of which the apex angle is bisected by the virtual line, and the center point is expressed by:
$$D = \frac{{\sum }_{i = 1}^{i = M} {D}_{pi}}{M}$$
wherein
M indicates the number of prisms,
Dpi indicates an average of a a horizontal distance by which a light output from an ith prism is spaced apart from a center of a left eye and a horizontal distance by which a light output from the ith prism is spaced apart from a center of a right eye, and
a prism proximate to the first edge of the light guide unit is a first prism.

19. The backlight unit of claim 18, wherein
a first tilt angle is formed by the first tilt surface and the virtual line, and
a second tilt angle is formed by the second tilt surface and the virtual line.

20. The backlight unit of claim 19, wherein the first tilt angle of the first prism is larger than a second tilt angle of a prism farthest from the first prism.

21. The backlight unit of claim 19, wherein from a prism of which an apex angle is bisected by the virtual line, the first tilt angle decreases toward the first edge of the light guide unit and the second tilt angle increases toward the first edge of the light guide unit.

22. The backlight unit of claim 19, wherein from a prism of which an apex angle is bisected by the virtual line, the first tilt angle increases toward the second edge of the light guide unit and the second tilt angle decreases toward the second edge of the light guide unit.

23. The backlight unit of claim 1,
the prism sheet further comprises a lower surface opposing the light exiting surface thereof
wherein each of the prisms includes a first tilt surface which is connected to the lower surface, and a second tilt surface which intersects the first tilt surface and is connected to the lower surface, and
wherein a prism of which an apex angle is bisected by a virtual line perpendicular to the lower surface and passing through an intersected point of the first and second tilt surfaces, is spaced apart from a center point of the prism sheet, the center point at half a distance between edges of the prism sheet, and the edges of the prism sheet respectively adjacent to the light source units, is expressed by:
$$D = \frac{{\sum }_{i = 1}^{i = M} {D}_{pi}}{M}$$
wherein
M indicates the number of prisms, and
Dpi indicates a difference between a first distance and a second distance, the first distance being a distance between an ith prism and the prism of which an apex angle is bisected by the virtual line and the second distance being a distance between the ith prism and the center point.

24. The backlight unit of claim 1, wherein
the first light guide plates comprises a light incident surface at the first edge of the light guide unit,
the second light guide plate comprises a light incident surface at the second edge of the light guide unit, and
each of the first and second light guide plates comprises a plurality of prisms on the light incident surface.

25. The backlight unit of claim 1, wherein a pitch between the lenses of the lens sheet is equal to a pitch between the prisms of the prism sheet.

26. A display device comprising:
a backlight unit; and
a display panel including a plurality of pixels which display an image using a light supplied from the backlight unit,
wherein the backlight unit comprises:
a light guide unit comprising a first edge, a second edge opposed to the first edge, and a light exiting surface which connects the first edge and the second edge;
light source units adjacent to the first and second edges of the light guide unit, respectively;
a prism sheet between the light guide unit and the display panel, and comprising a plurality of prisms on a surface of the prism sheet, which faces the light guide unit; and
a lens sheet between the prism sheet and the display panel, and comprising a plurality of lenses,
wherein
the light guide unit comprises a first light guide plate and a second light guide plate,
a thickness of a region of the first light guide plate adjacent to the first edge is greater than a thickness of a region of the first light guide plate adjacent to the second edge, and
a thickness region of the second light guide plate adjacent to the second edge is greater than a thickness of a region of the second light guide plate adjacent to the first edge.

27. The display device of claim 26, wherein
the prisms are arranged from a first edge adjacent to a first light source unit, to a second edge opposing the first edge and adjacent to a second light source unit;
the plurality of lenses of the lens sheet are on one of a surface thereof facing the prism sheet and a surface thereof opposite to the prism sheet, and are arranged from a third edge thereof adjacent to the first light source unit to a fourth edge thereof adjacent to the second light source unit; and
a distribution distance of a light which passes through the lens sheet and diffused to an entire eye area of a viewer, is determined by P(L_{VD}−L)/L, wherein P indicates a pitch between lenses, L indicates a focusing distance of a lens, and L_{VD} indicates a viewing distance of the viewer.

28. The display device of claim 27, wherein the pitch between lenses is equal to or less than one third of a pixel width

29. The display device of claim 26, wherein
a lateral surface of the first light guide plate corresponds to the first edge of the light guide unit, and
a lateral surface of the second light guide plate corresponds to the second edge,
wherein the lateral surfaces are inclined with respect to the light exiting surface of the light guide unit.

30. The display device of claim 26, further comprising a plurality of prisms on the lateral surfaces of the light guide unit.

31. The display device of claim 26, wherein
the prism sheet further comprises a lower surface opposing the light exiting surface thereof, and
each prism includes:
a first tilt surface which extends from the lower surface in a direction inclined with respect to a direction perpendicular to the lower surface;
a second tilt surface which extends from the lower surface in a direction which intersects with a virtual line of the first tilt surface; and
a connection surface which connects the first tilt surface and the second tilt surface.

32. The display device of claim 31, wherein
an angle formed by a virtual line bisecting an apex angle of the each prism and a virtual line perpendicular to the lower surface of the prism sheet becomes larger as a prisms are closer to first and second edges of the prism sheet with respect to a center point of the prism sheet,
the first and second edges of the prism sheet respectively adjacent to the light source units, and the center point at half a distance between the first and second edges of the prism sheet, and
the apex angle formed by the first tilt surface, and a virtual line of the second tilt surface.

33. The display device of claim 32, wherein a distance between the connection surface and the lower surface of the prism sheet is larger than a distance between the lower surface of the prism sheet and a point at which the first or second tilt surface, and the connection surface meet.

34. The display device of claim 33, wherein a radius of curvature of the connection surface is expressed by:
$$r = h / ( 1 - sin \frac{α}{2} )$$
wherein
h is a difference between a maximum distance between the connection surface and the lower surface of the prism sheet, and a maximum distance between the first or second tilt surface, and the lower surface, and
α is an angle corresponding to the apex angle.

35. The display device of claim 34, wherein a ratio of an amount of light output from the light guide unit and incident onto the prism sheet, to an amount of light output from the light guide unit and incident onto the connection surface is expressed by:
$$p = \frac{h}{H}$$
wherein H indicates a difference between a maximum distance and a minimum distance, the maximum distance being a distance between the connection surface and the lower surface, and the minimum distance being a distance between the lower surface and a region where a light output from the light guide unit reaches the first tilt surface or the second tilt surface.

36. The display device of claim 32, wherein the connection surface comprises:
a third tilt surface which is connected with the first tilt surface and comprises a sub tilt surface; and
a fourth tilt surface which connects the second and third tilt surfaces, and comprises a sub tilt surface.

37. The display device of claim 36, wherein a distance between the lower surface and a connection point of the third and fourth tilt surfaces is greater than a distance between the lower surface and a connection point of the first and third tilt surfaces or a connection point of the second and fourth tilt surfaces.

38. The display device of claim 37, wherein
the third tilt surface comprises a first sub tilt surface and a second sub tilt surface, and
the fourth tilt surface comprises a third sub tilt surface and a fourth sub tilt surface,
the first sub tilt surface connecting the first tilt surface and the second sub tilt surface, the third sub tilt surface connecting the second tilt surface and the fourth sub tilt surface, and the second and fourth sub tilt surfaces meeting at the connection point of the second and fourth tilt surfaces.

39. The display device of claim 26,
the prism sheet further comprises a lower surface opposing the light exiting surface thereof
wherein each of the prisms includes a first tilt surface which is connected to the lower surface, and a second tilt surface which intersects the first tilt surface and is connected to the lower surface, and
wherein a prism of which an apex angle is bisected by a virtual line perpendicular to the lower surface and passing through an intersected point of the first and second tilt surfaces, is spaced apart from a center point of the prism sheet,
the center portion at half a distance between edges of the prism sheet, the edges of the prism sheet respectively adjacent to the light source units, and the apex angle formed by the first and second tilt surfaces.

40. The display device of claim 39, wherein a distance between a prism of which the apex angle is bisected by the virtual line and the center is expressed by:
$$D = \frac{{\sum }_{i = 1}^{i = M} {D}_{pi}}{M}$$
wherein
M indicates the number of prisms,
Dpi indicates an average of a a horizontal distance by which a light output from an ith prism is spaced apart from a center of a left eye, and a horizontal distance by which a light output from the ith prism is spaced apart from a center of a right eye, and
a prism proximate to the first edge of the light guide unit is a first prism.

41. The display device of claim 40, wherein
a first tilt angle is formed by the first tilt surface and the virtual line, and
a second tilt angle is formed by the second tilt surface and the virtual line.

42. The display device of claim 41, wherein the first tilt angle of the first prism is larger than a second tilt angle of a prism farthest from the first prism.

43. The display device of claim 41, wherein from a prism of which an apex angle is bisected by the virtual line, the first tilt angle decreases toward the first edge of the light guide unit and the second tilt angle increases toward the first edge of the light guide unit.

44. The display device of claim 41, wherein from a prism of which an apex angle is bisected by the virtual line, the first tilt angle increases toward the second edge of the light guide unit and the second tilt angle decreases toward the second edge of the light guide unit.

45. The display device of claim 26,
the prism sheet further comprises a lower surface opposing the light exiting surface thereof
wherein each of the prisms includes a first tilt surface which is connected to the lower surface, and a second tilt surface which intersects the first tilt surface and is connected to the lower surface, and
wherein a distance between a prism of which an apex angle is bisected by a virtual line perpendicular to the lower surface and passing through an intersected point of the first and second tilt surfaces and a center point point of the prism sheet, the center point at half a distance between edges of the prism sheet, and the edges of the prism sheet respectively adjacent to the light source units, is expressed by:
$$D = \frac{{\sum }_{i = 1}^{i = M} {D}_{pi}}{M}$$
wherein
M indicates the number of prisms, and
Dpi indicates a difference between a first distance and a second distance, the first distance being a distance between an ith prism and the prism of which an apex angle is bisected by the virtual line and the second distance being a distance between the ith prism and the center point.

46. The display device of claim 26, wherein a pitch between the lenses of the lens sheet is equal to a pitch between the prisms of the prism sheet.
